(19) United States
(12) Patent Application Publication
(10) Pub. No.: US 2023/0403573 A1
(43) Pub. Date: Dec. 14, 2023

(54) MANAGING A RADIO ACCESS NETWORK OPERATION

(71) Applicant: Telefonaktiebolaget LM Ericsson (publ), Stockholm (SE)

(72) Inventors: Henrik Rydén, Stockholm (SE); Pablo Soldati, Solna (SE)

(21) Appl. No.: 18/030,517

(22) PCT Filed: Sep. 21, 2021
(86) PCT No.: PCT/SE2021/050912

§ 371 Date: Apr. 6, 2023

Related U.S. Application Data
(60) Provisional application No. 63/089,050, filed on Oct. 8, 2020.

(51) Int. Cl. H04W 24/02; H04L 41/16

(52) U.S. Cl. CPC H04W 24/02; H04L 41/16

(57) ABSTRACT

A method is disclosed for managing a Radio Access Network (RAN) operation performed by a first node in a communication network that comprises a RAN. The method is performed by the first node and comprises receiving a representation of a state of a second node with respect to the RAN operation, wherein the state of the second node comprises a compressed representation of parameter values that describe at least one of a physical state, a radio environment or a physical environment experienced by the second node or experienced by at least one node that is connected to the communication network via the second node. The method further comprises using the received state representation to generate a configuration action for the RAN operation and initiating configuration of the RAN operation in accordance with the generated configuration action.

### TECHNICAL FIELD

The present disclosure relates to a method for managing and a method for facilitating a Radio Access Network (RAN) operation performed by a first node in a communication network that comprises a Radio Access Network. The methods are performed by the first node and by a second node. The present disclosure also relates to a first node, a second node, and to a computer program product configured, when run on a computer, to carry out a method for managing and/or facilitating a RAN operation performed b y a first node.

### BACKGROUND

Machine Learning (ML) is a branch of Artificial Intelligence (AI), and refers to the use of algorithms and statistical models to perform a task. ML generally involves a training phase, in which algorithms build a computational operation based on some sample input data, and an inference phase, in which the computational operation is used to make predictions or decisions without being explicitly programmed to perform the task. Support for ML in communication networks is an ongoing challenge. The 3rd Generation Partnership Project (3GPP) has proposed a study item on “Radio Access Network (RAN) intelligence (Artificial Intelligence/Machine Learning) applicability and associated use cases (e.g. energy efficiency, RAN optimization), which is enabled by Data Collection”. Proposals for the scope of the study item include:
1. The framework (e.g. including the functionality and input/output of the component for AI enabled optimization) or high level principles for RAN intelligence enabled by AI.
2. Use cases and benefits of AI enabled 5G RAN, e.g. energy saving, load balancing, beam management, air interface optimization, etc.
3. Standardization impact for the identified use cases, including:
   a) The data may be needed by an AI function as input and data that may be produced by an AI function as output, which is interpretable for multi-vendor support;
   b) Related node or function in RAN, Core Network, Operations Administration and Maintenance, etc. to provide/collect/store the data, or host the AI model/algorithm;
   c) Interface to convey the input/output data among network nodes or functions.

Integrating the use of ML models into existing operational procedures involves several challenges. One proposal is to signal an ML model to a UE for execution, as opposed to executing the ML model for example in a Radio Access node. This has been for example discussed in an internal reference document, in which a model is signalled to a device for making improved handover decisions. Signalling an ML model to a UE for execution can offer several benefits, including resource saving at the radio access node, avoiding the need for the UE to signal input data, and consequently the possibility to execute the model more frequently, for example every time the UE obtains a new value of a model input parameter. However, signalling of an ML model to a UE also involves certain challenges. Signalling a model, and specifying input format etc. to a UE, is associated with a cost, and frequent model signalling, or the need to signal a very large model, can therefore mitigate the benefits of executing the model in the UE. In addition, model complexity (execution time, memory consumption, etc.) might not be appropriate for all types of devices. In addition, during a training phase, the UE is required to report a large amount of measurements in order to enable the network to build an effective ML model. This will limit the type of measurements that can be used to train the model, and some measurements, for example including as geo-location, may not be reported owing to privacy concerns.

Another challenge associated with introducing ML in wireless networks is the need to define what features should be signalled between network nodes in order to support execution of ML models in the relevant entities. This requires substantial standardization effort, which implies a long delay between identifying a new useful feature and that feature being available for use as input to an ML model deployed in a wireless network.

### SUMMARY

It is an aim of the present disclosure to provide methods, first and second nodes and a computer readable medium which at least partially address one or more of the challenges mentioned above. It is a further aim of the present disclosure to provide methods, a first and second node and a computer readable medium which cooperate to facilitate the configuration of a RAN operation, and the provision of relevant state information on the basis of which such an operation may be configured.

According to a first aspect of the present disclosure, there is provided a computer implemented method for managing a Radio Access Network (RAN) operation performed by a first node in a communication network that comprises a Radio Access Network. The method, performed by the first node, comprises receiving a representation of a state of a second node with respect to the RAN operation, wherein the state of the second node comprises a compressed representation of parameter values that describe at least one of a physical state, a radio environment or a physical environment experienced by the second node or experienced by at least one node that is connected to the communication network via the second node. The method further comprises using the received state representation to generate a configuration action for the RAN operation, and initiating configuration of the RAN operation in accordance with the generated configuration action.

According to another aspect of the present disclosure, there is provided a computer implemented method for facilitating a RAN operation performed by a first node in a communication network that comprises a RAN. The method, performed by a second node, comprises generating a state of the second node with respect to the RAN operation, wherein the state of the second node comprises a compressed representation of parameter values that describe at least one of a physical state, a radio environment or a physical environment experienced by the second node or by at least one node that is connected to the communication network via the second node. The method further comprises transmitting a representation of the generated state to at least one of the first node or a node of the communication network that is operable to communicate with the first node.

According to another aspect of the present disclosure, there is provided a computer program product comprising a computer readable medium, the computer readable medium having computer readable code embodied therein, the computer readable code being configured such that, on execution by a suitable computer or processor, the computer or processor is caused to perform a method according to any one of the preceding aspects of the present disclosure.

According to another aspect of the present disclosure, there is provided a first node in a communication network comprising a RAN. The first node is for managing a RAN operation performed by the first node and comprises processing circuitry. The processing circuitry is configured to receive a representation of a state of a second node with respect to the RAN operation, wherein the state of the second node comprises a compressed representation of parameter values that describe at least one of a physical state, a radio environment or a physical environment experienced by the second node or by at least one node that is connected to the communication network via the second node. The processing circuitry is further configured to use the received state representation to generate a configuration action for the RAN operation, and initiate configuration of the RAN operation in accordance with the generated configuration action.

According to another aspect of the present disclosure, there is provided a second node in a communication network comprising a RAN. The second node is for facilitating a RAN operation performed by a first node in the communication network and comprises processing circuitry. The processing circuitry is configured to generate a state of the second node with respect to the RAN operation, wherein the state of the second node comprises a compressed representation of parameter values that describe at least one of a physical state, a radio environment or a physical environment experienced by the second node or by at least one node that is connected to the communication network via the second node. The processing circuitry is further configured to transmit a representation of the generated state to at least one of the first node or a node of the communication network that is operable to communicate with the first node.

Aspects of the present disclosure thus provide a framework for signalling a representation of a state of a second node, which state may be used by a first node to generate a configuration action for a Radio Access Network (RAN) operation performed by the first node. The state of the second node may be referred to as a compressed state, as it comprises a compressed representation of parameter values. The first node may have no prior knowledge of the meaning of the state, other than for example that it relates to a certain RAN operation. The first node is not required to decompress the parameter values but rather uses the received state representation directly to generate a configuration action. In some examples of the present disclosure, a Reinforcement Learning process may be used to learn the optimal configuration action for a given received state representation.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a flow chart illustrating process steps in a method performed by a first node for managing a RAN operation;

FIG. 2 is a flow chart illustrating process steps in a method performed by a second node for facilitating a RAN operation;

FIGS. 3a to 3f show a flow chart illustrating process steps in another example of a method performed by a first node for managing a RAN operation;

FIGS. 4a to 4c show a flow chart illustrating process steps in another example of a method performed by a second node for facilitating a RAN operation;

FIG. 5 illustrates an Autoencoder for CSI compression;

FIG. 6 is a block diagram illustrating functional modules in a first node;

FIG. 7 is a block diagram illustrating functional modules in another example of a first node;

FIG. 8 is a block diagram illustrating functional modules in a second node;

FIG. 9 is a block diagram illustrating functional modules in another example of a second node;

FIG. 10 illustrates a deployment plot of an area served by a communication network;

FIGS. 11a and 11b illustrate different areas served by a RAN node;

FIGS. 12a and 12b illustrate a representation of a state of a second node;

FIG. 13 illustrates state representation for beam configuration;

FIGS. 14a and 14b illustrate how a state representation can be mapped to coverage on a different frequency;

FIG. 15 illustrates a wireless network in accordance with some examples;

FIG. 16 illustrates a User Equipment in accordance with some examples;

FIG. 17 illustrates a virtualization environment in accordance with some examples;

FIG. 18 illustrates a telecommunication network connected via an intermediate network to a host computer in accordance with some examples;

FIG. 19 illustrates a host computer communicating via a base station with a user equipment over a partially wireless connection in accordance with some examples;

FIG. 20 illustrates methods implemented in a communication system including a host computer, a base station and a user equipment in accordance with some examples;

FIG. 21 illustrates methods implemented in a communication system including a host computer, a base station and a user equipment in accordance with some examples;

FIG. 22 illustrates methods implemented in a communication system including a host computer, a base station and a user equipment in accordance with some examples; and

FIG. 23 illustrates methods implemented in a communication system including a host computer, a base station and a user equipment in accordance with some examples.

### DETAILED DESCRIPTION

As discussed above, examples of the present disclosure provide a framework for the signalling and use of a “compressed state”, wherein the compressed state comprises a compressed representation of parameter values. The parameter values describe at least one of a physical state, a radio environment or a physical environment experienced by a second node or experienced by at least one node that is connected to a communication network via the second node, for example if the second node is a Radio Access node such as a base station. A representation of the compressed state is received by a first node, which may have no prior knowledge of the meaning of the compressed state, other than in certain examples that the compressed state relates to a particular RAN operation. The first node can use the compressed state to generate a configuration action for the RAN operation, for example using Reinforcement Learning (RL). In one example, if the RAN operation is link-adaptation, a second node in the form of a UE would signal a representation of a “link-adaptation-state” to a first node in the form of a Radio Access node. The “link-adaptation-state” could for example comprise a compressed representation of interference and noise level parameters. In another example, if the RAN operation is scheduling, second nodes in the form of Radio Access nodes could signal a representation of a “scheduling-state” to a neighbouring first node also in the form of a Radio Access node. The “scheduling-state” could for example comprise a compressed representation of parameter values relating to scheduling decisions, including number of connected UEs, Bandwidth use, scheduling decisions, Time Division Duplex settings, etc. The parameter value could also comprise a predicted future value of the number of connected UEs or Bandwidth use.

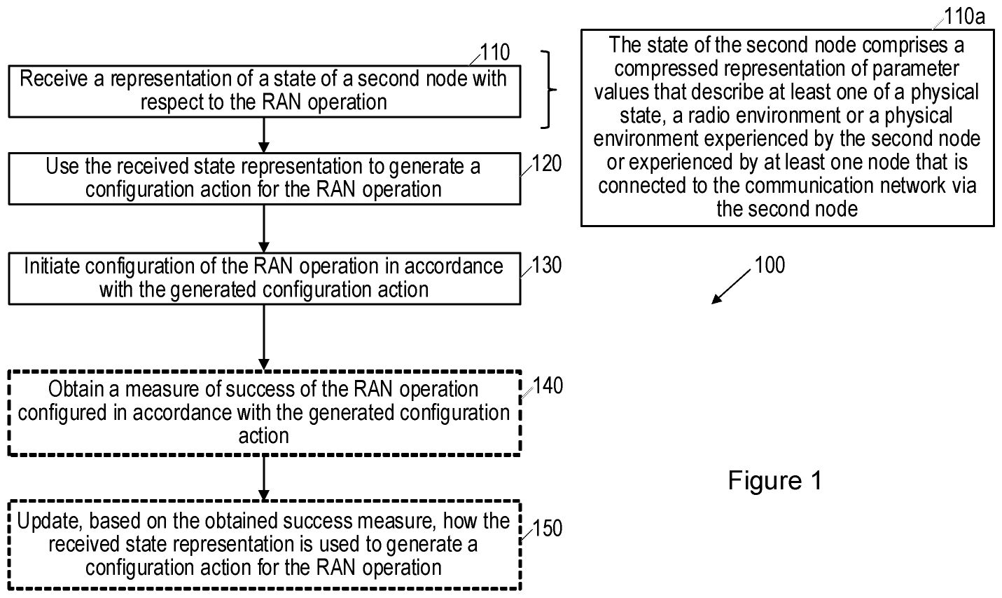

FIG. 1 is a flow chart illustrating process steps in a method 100 for managing a Radio Access Network (RAN) operation performed by a first node in a communication network that comprises a Radio Access Network. The method is performed by the first node, which may in some examples be a RAN node of the communication network. A RAN node of a communication network comprises a node that is operable to transmit, receive, process and/or orchestrate wireless signals. A RAN node may comprise a physical node and/or a virtualised network function. In some examples, a RAN node may comprise a base station node such as a NodeB, eNodeB, gNodeB, or any future implementation of the above discussed functionality.

Referring to FIG. 1, the method 100 comprises, in step 110, receiving a representation of a state of a second node with respect to the RAN operation to be managed. The second node may comprise at least 35 one of a RAN node of the communication network or a wireless device such as a UE that is operable to connect to the communication network. As illustrated at 110a, the state of the second node comprises a compressed representation of parameter values that describe at least one of a physical state, a radio environment or a physical environment experienced by the second node or experienced by at least one node that is connected to the communication network via the second node. For example, if the second node is a RAN node, the state of the second node may in some cases be comprised of compressed mobility (or other) measurements from its connected UEs, and so the parameter values of the state describe the radio environment of the connected UEs, rather than the radio environment of the second node itself. In other examples, the state of the second node may be comprised of compressed parameter values describing the physical state, radio environment or physical environment of the second node itself, irrespective of whether the second node is a RAN node or a wireless device.

In step 120, the method 100 comprises using the received state representation to generate a configuration action for the RAN operation. A configuration action may comprise any action which will in some manner configure the RAN operation, so controlling the manner in which the RAN operation is performed. The nature of the configuration may depend upon the particular RAN operation but may include timing of the operation, activation of the operation, setting of parameters controlling execution of the operation, etc. It will be appreciated that using the received state representation to generate a configuration action for the RAN operation does not require the first node to decompress the compressed parameter values of the state. Rather, the first node may use the received representation of the state directly, for example mapping the state or its representation to a generated configuration action, for example using a Machine Learning process, as discussed in further detail below.

The method 100 further comprises, in step 130, initiating configuration of the RAN operation in accordance with the generated configuration action, and the method 100 may further comprise executing or performing the RAN operation, configured according to the generated configuration action.

As illustrated in steps 140 and 150, the method 100 may in some examples further comprise obtaining a measure of success of the RAN operation configured in accordance with the generated configuration action, and updating, based on the obtained success measure, how the received state representation is used to generate a configuration action for the RAN operation.

The RAN operation performed by the first node, and which is configured according to the generated configuration action, may be configured by the first node itself or by another node of the communication network or a connected wireless device. In such examples, initiating configuration of the RAN operation may comprise sending the generated configuration action to the relevant node or wireless device. For the purposes of the present disclosure, a RAN operation may comprise any operation that is at least partially performed by the first node in the context of connection of one or more wireless devices to the Radio Access Network. For example, a RAN operation may comprise a connection operation, a mobility operation, a reporting operation, a resource configuration operation, a synchronisation operation, a traffic management operation, a scheduling operation etc. Specific examples of RAN operations may include Link Adaptation, Scheduling, mobility, Inter and intra-frequency handover, positioning, beamforming, Uplink and downlink synchronisation, random access, uplink power control, wireless signal reception/transmission, etc. Further examples of RAN operations are discussed below, with reference to FIGS. 1 to 4c. Any one of more of these example operations or operation types may be configured via a configuration action that is generated using a received representation of a “compressed state” of a second node.

The parameters that may be included in the compressed state may describe a physical state, and/or the physical or radio environment experienced by the second node or experienced by nodes connected to the communication network via the second node. Parameters describing the physical state of a node may include parameters describing battery power, memory, processing or computational capacity, sensor values obtained from sensors associated with the node (accelerometers, pressure sensors, light sensors, etc.). Parameters describing the physical environment experienced by the second node or a node connected via the second node may for example be obtained using cameras, lidars, GNSS, etc. and may include parameters such as geolocation, indoor/outdoor estimation, physical velocity or acceleration, nearby infrastructure detected (buildings, roads, etc.), nearby natural features detected (hills, mountains etc.), nearby detected antenna towers. Parameters describing the radio environment experienced by the second node or a node connected via the second node may include parameters such as signal power, interference and noise levels, detected presence of Line-of-sight components, delay-spread, angle-of-arrival etc. Each of these parameters may be measured for each of the detected signals from any given RAN node, as for example a number of reference or other signals may be detected from each RAN node in the vicinity of the second node or its connected devices. Each reference signal per RAN node can for example be associated to a specific beam at the node.

The radio-environment can also comprise other Radio access technologies than New Radio/Long Term Evolution NR/LTE. It could also comprise WiFi or Bluetooth measurements. The second node can include for example a number of detected WiFI or Bluetooth nodes, identifiers of the nodes, and/or associated signal power measurements on each of the nodes.

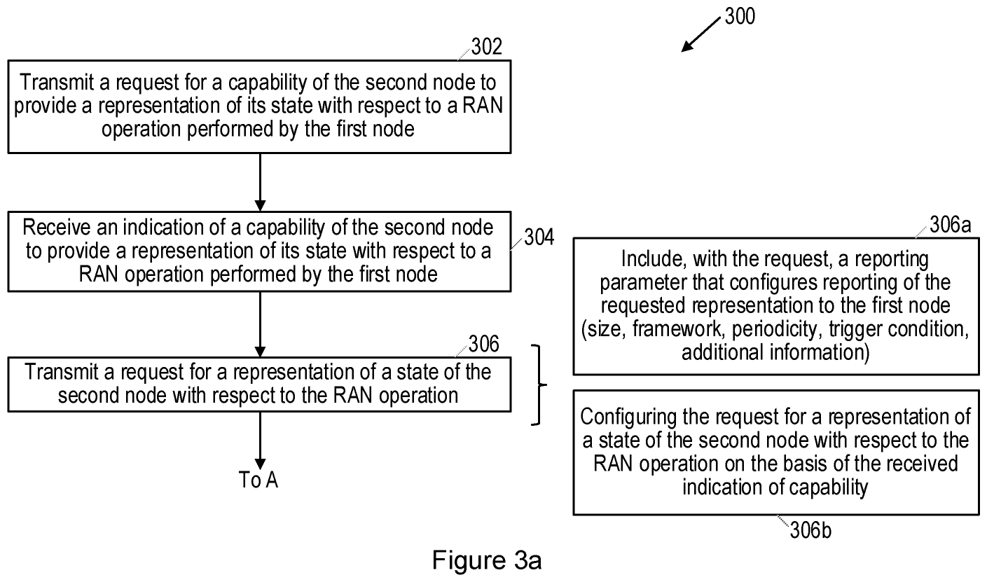

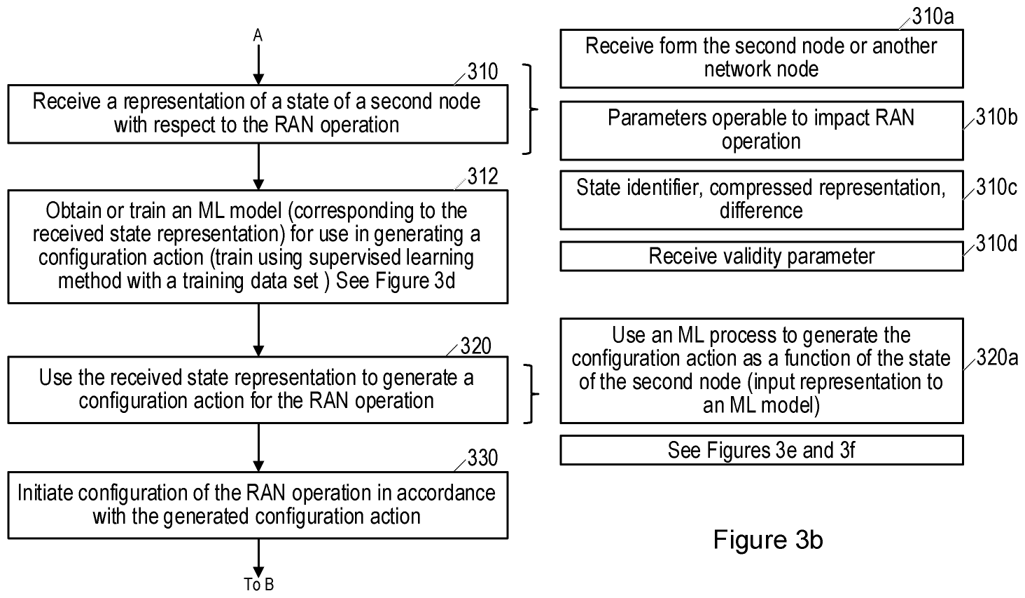

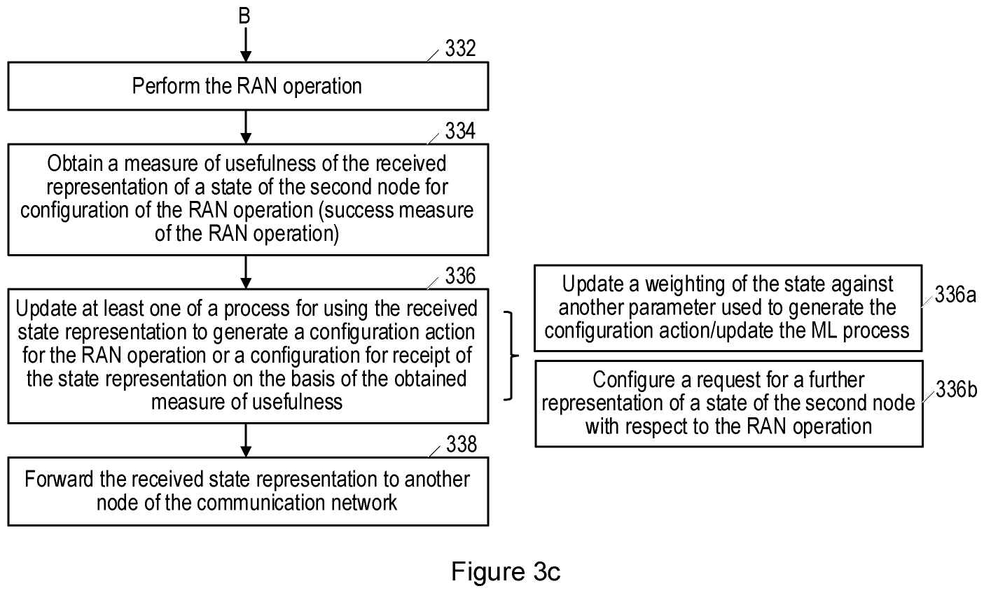

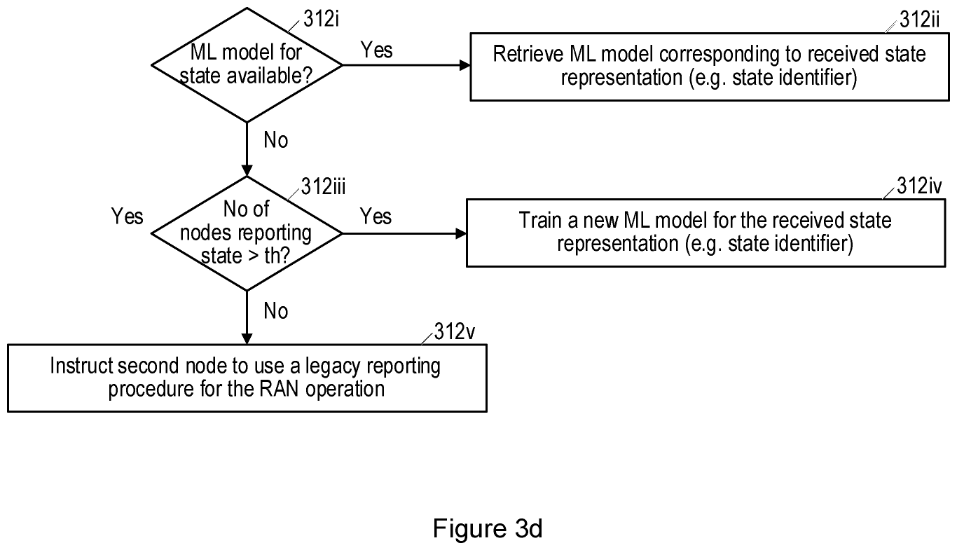

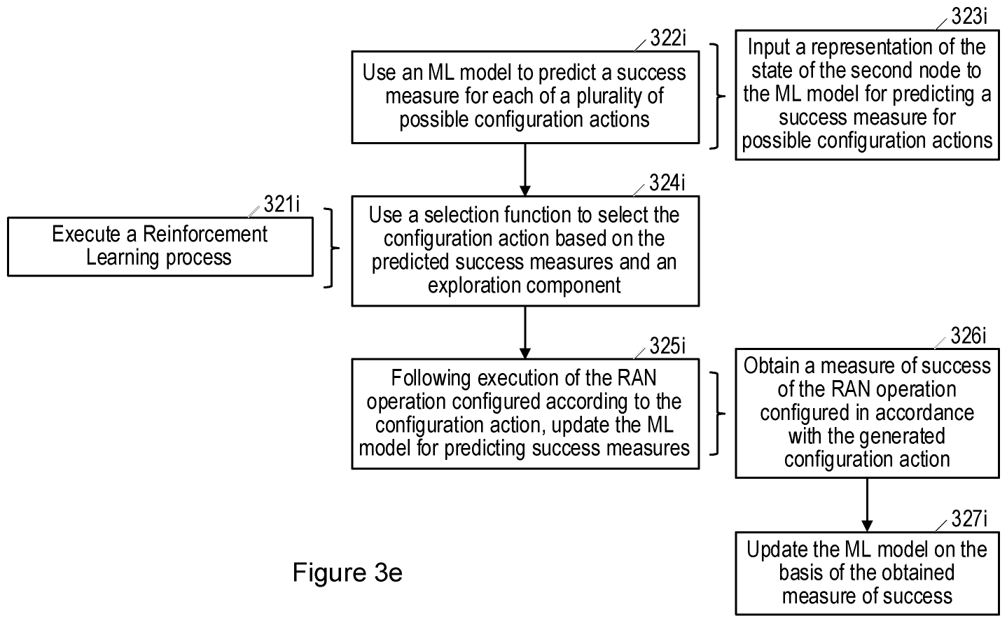

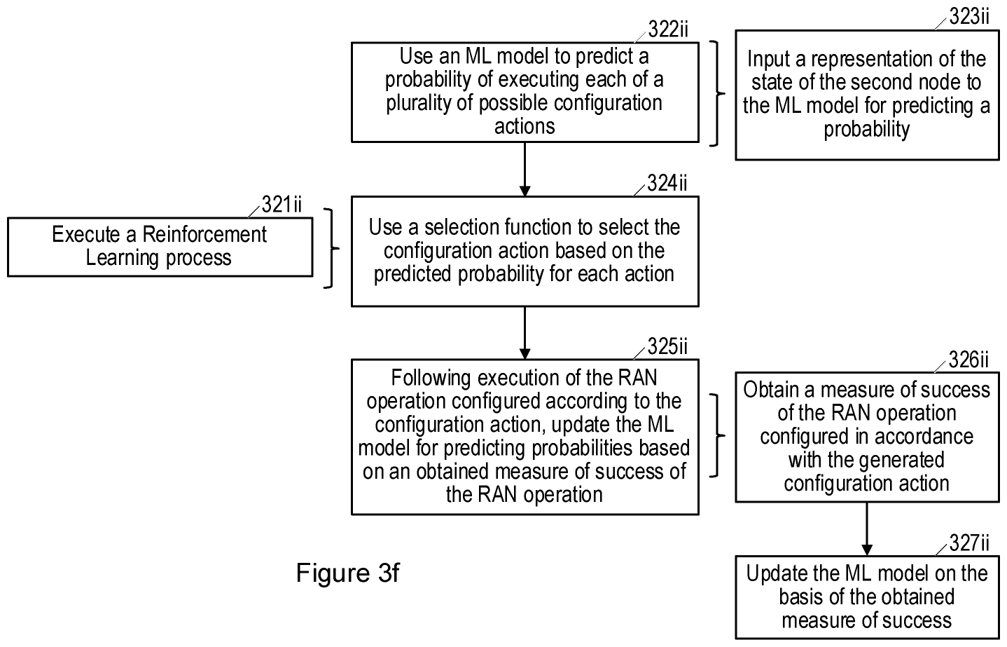

As discussed in greater detail below with reference to FIGS. 3a to 3d, the representation of the state of the second node that is received in step 110 may comprise the compressed values of the state, or may comprise a state identifier, or a delta encoding with reference to a previously received state.

According to another example of the present disclosure, there is provided a computer implemented method for managing a mobility operation performed by a first node in a communication network that comprises a Radio Access Network, the first node comprising a RAN node, the method, performed by the first node, comprising:
receiving a representation of a mobility state of a second node, wherein the second node comprises a wireless device, and wherein the mobility state of the second node comprises a compressed representation of parameter values that describe at least one of a physical state, a radio environment or a physical environment experienced by the second node;
using the received state representation to generate a configuration action for the mobility operation; and
initiating configuration of the mobility operation in accordance with the generated configuration action.

The method may further comprise executing the mobility operation as configured. In some examples, the first node may use a Machine Learning (ML) process to predict communication network coverage for the second node on different carriers on the basis of the received representation of a mobility state of the second node. The first node may then configure one or more parameters for a mobility operation, including for example Handover margin, Time to Trigger, etc. The parameter values represented in the mobility state of the second node may comprise values of parameters operable to impact execution of the mobility operation (e.g. handover) performed by the first node. Such parameters may include for example geolocation, velocity, signal power of detected signals form one or more RAN nodes, etc.

According to another example of the present disclosure, there is provided a computer implemented method for facilitating a mobility operation performed by a first node in a communication network that comprises a Radio Access Network, the first node comprising a RAN node, the method, performed by a second node that comprises a wireless device, comprising:
generating a mobility state of the second node, wherein the mobility state of the second node comprises a compressed representation of parameter values that describe at least one of a physical state, a radio environment or a physical environment experienced by the second node; and
transmitting a representation of the generated mobility state to at least one of the first node or a node of the communication network that is operable to communicate with the first node.

As discussed above, the parameter values represented in the mobility state of the second node may comprise values of parameters operable to impact execution of the mobility operation (e.g. handover) performed by the first node. Such parameters may include for example geolocation, velocity, signal power of detected signals form one or more RAN nodes, etc.

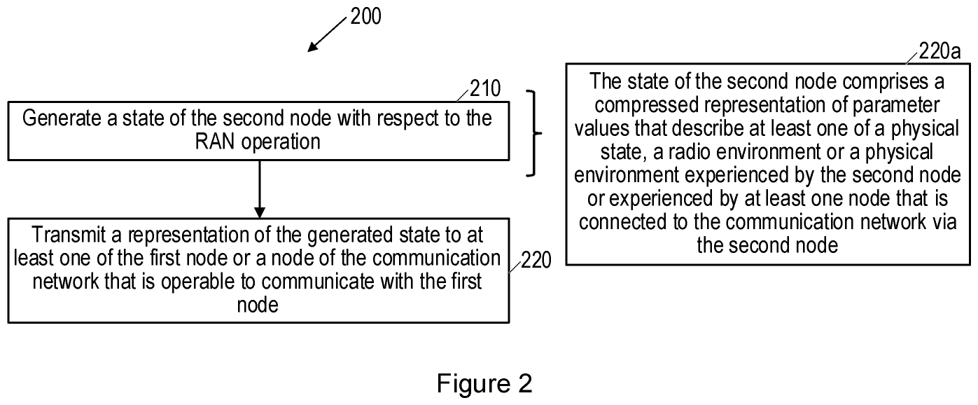

The method 100 may be complimented by a method 200 performed by a second node. FIG. 2 is a flow chart illustrating process steps in a method 200 for facilitating a RAN operation performed by a first node in a communication network that comprises a RAN. The second node may comprise a RAN of the communication network or a wireless device such as a UE operable to connect to the communication network. The first node may comprise a RAN node of the communication network. Referring to FIG. 2, the method 200 comprises, in a first step 210, generating a state of the second node with respect to the RAN operation. As illustrated at 210a, the state of the second node comprises a compressed representation of parameter values that describe at least one of a physical state, a radio environment or a physical environment experienced by the second node or by at least one node that is connected to the communication network via the second node. The method 200 further comprises, at step 220, transmitting a representation of the generated state to at least one of the first node or a node of the communication network that is operable to communicate with the first node.

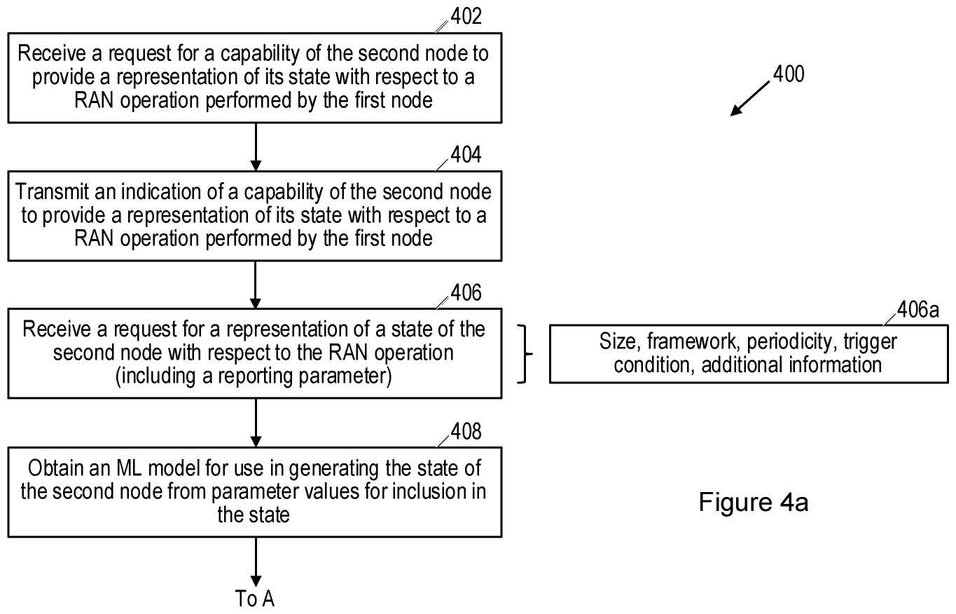

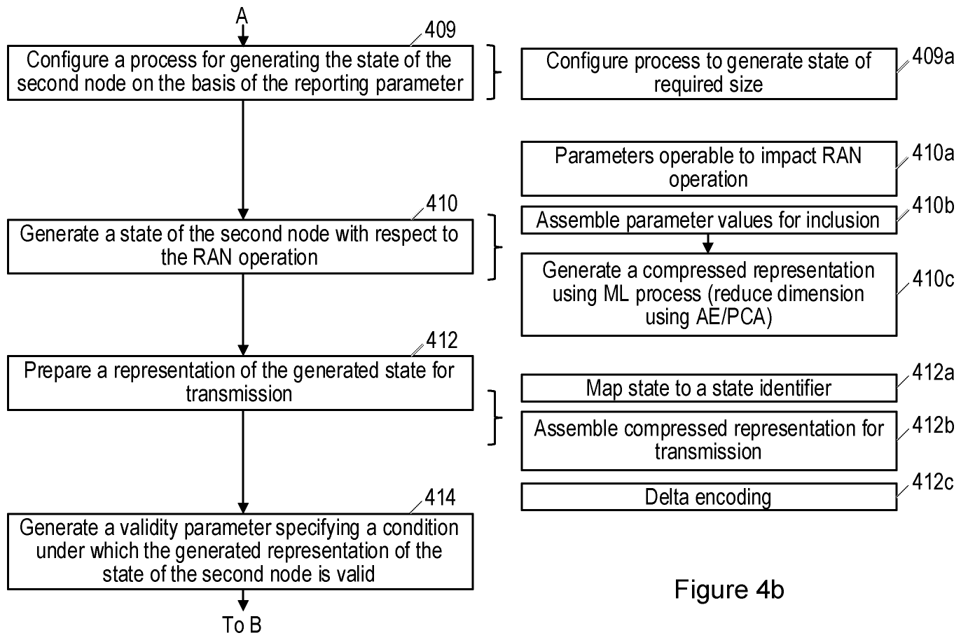

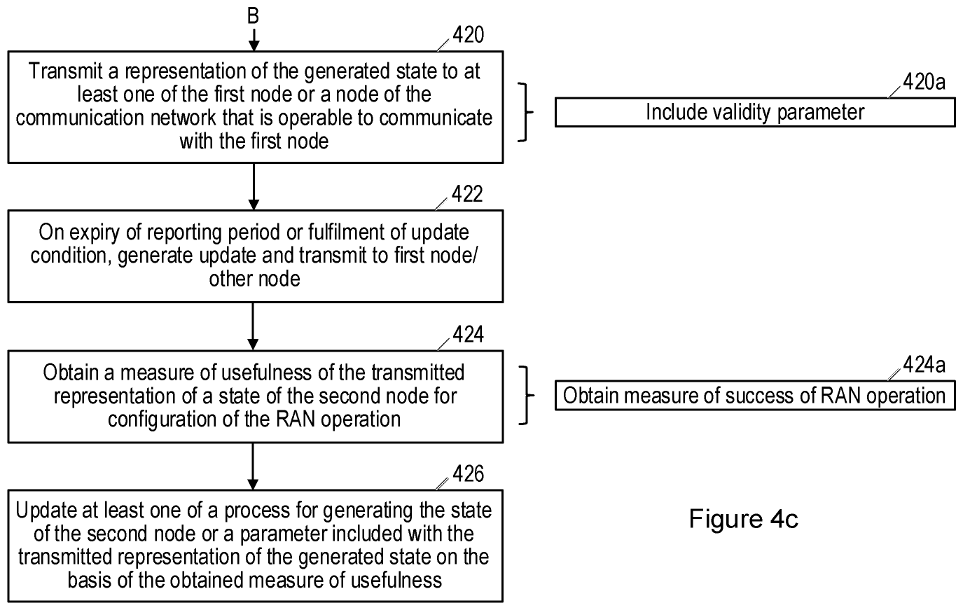

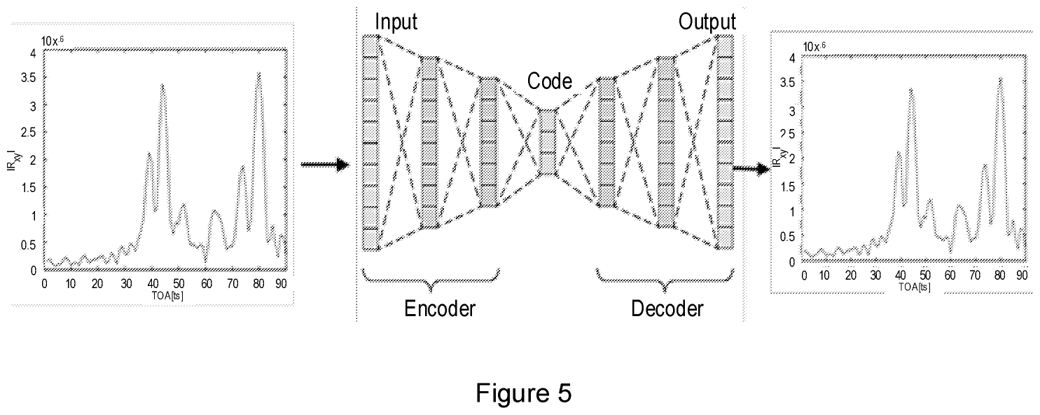

FIGS. 3a to 3f, and 4a to 4c, show flow charts illustrating process steps in further examples of methods 300 and 400 for managing and facilitating a RAN operation performed by a first node in a communication network.

Referring initially to FIGS. 3a to 3f, the method 300 provides various examples of how the steps of the method 100 may be implemented and supplemented to achieve the above discussed and additional functionality. As for the method 100, the method 300 is performed by the first node, which may in some examples be a RAN node of the communication network. As discussed above, a RAN node of a communication network comprises a node that is operable to transmit, receive, process and/or orchestrate wireless signals. A RAN node may comprise a physical node and/or a virtualised network function. In some examples, a RAN node may comprise a base station node such as a NodeB, eNodeB, gNodeB, or any future implementation of the above discussion functionality.

Referring to FIG. 3a, in a first step 302, the first node transmits a request for a capability of the second node to provide a representation of its state with respect to a RAN operation performed by the first node. The capability request may specify the RAN operation in question, multiple RAN operations, or may be an open request for capabilities to provide a state representation with respect to any RAN operation. In step 304, the first node receives an indication of a capability of the second node to provide a representation of its state with respect to a RAN operation performed by the first node. The first node then transmits, in step 306, a request for a representation of a state of the second node with respect to the RAN operation. The request may be transmitted to the second node or to another node that is operable to provide the state. This may be appropriate for example in a split architecture scenario, in which centralised and distributed units may forward state representations received from UEs, or in the case of forwarding between RAN nodes in a non-split architecture.

As illustrated at 306a, the first node may include, with the request for a representation of a state of the second node with respect to the RAN operation, a reporting parameter that configures reporting of the requested representation to the first node. The reporting parameter may specify at least one of:
a size of the compressed representation of parameter values that will comprise the state;
a framework for identifying the state;
a reporting periodicity for reporting an updated representation of the state to the first node;
a trigger condition for reporting an updated representation of the state to the first node; and/or additional information to be included with the representation of the state.

As illustrated at step 306b, the first node may configure the request for a representation of a state of the second node with respect to the RAN operation on the basis of the received indication of capability. Such configuring may comprise setting one or more of the reporting parameters discussed above on the basis of the capabilities signalled by the second node. In some examples, if the signalled capabilities indicate that the second node supports using more than one different method to generate the requested state, the first node may indicate a method to be used in generating the state.

Referring now to FIG. 3b, in step 310, the first node receives a representation of a state of the second node with respect to the RAN operation, wherein the state of the second node comprises a compressed representation of parameter values that describe at least one of a physical state, a radio environment or a physical environment experienced by the second node or experienced by at least one node that is connected to the communication network via the second node. As illustrated at 310a, the representation of a state of the second node may be received from at least one of the second node or a communication network node other than the second node. For example, the representation may be received from another RAN node, a centralised or distributed unit associated with the first node, etc. As illustrated at 310b, the parameter values represented in the state of the second node may comprise values of parameters operable to impact execution of the RAN operation performed by the first node. The state information that is received may therefore be tailored to the particular RAN operation. It will be appreciated that a relatively large range of factors could impact execution, and therefore be of relevance for the configuration, of any given RAN operation. Parameters describing some of these factors may not currently be reported according to existing communication network standards, and so may not generally be associated with the configuration of the RAN operation according to existing network operation. However, examples of the present disclosure, through the provision of a representation of a compressed state, and the use of the representation to generate a configuration action directly, enable such factors to be taken into account.

As illustrated at 310c, the received representation of the state of the second node may comprise at least one of a state identifier for the state of the second node, the compressed representation of parameter values that comprises the state and/or an indication of difference from a previous state of the second node (a delta encoding).

A state identifier for a state of a second node comprises an identifier that is unique to a method or methods used to create the compressed representation of parameter values that comprises the state. As discussed above, the parameter values describe at least one of a physical state, a radio environment or a physical environment experienced by the second node or experienced by at least one node that is connected to the communication network via the second node. The same unique identifier for a state may therefore be used by multiple second nodes, providing those nodes have used the same method or methods to generate the state. Use of the same unique state identifier by a plurality of second nodes therefore implies that the nodes have used the same method for creating the state (that is the compressed representation of parameter values that describe at least one of a physical state, a radio environment or a physical environment). Considering the examples of autoencoders and PCA methods for state generation, two nodes reporting the same state identifier may be assumed by the first node to have used identical autoencoders to create the state (the compressed representation), or identical PCA methods to create the state (the compressed representation). It will be appreciated that two nodes may experience the same physical state, radio environment or physical environment, but report different state identifiers, having created different states (different compressed representations) through the use of different methods.

A particular physical state, radio environment or physical environment may be experienced by any one or more of a number of second nodes. If a particular compressed state is identical, for nodes reporting the same state identifier, the first network node knows that the same methods have been used to generate the states, and that the second nodes are therefore experiencing the same physical state, radio environment or physical environment. In this manner, learning obtained regarding how to use a received state identifier to generate a configuration action may be applied across different second nodes. For example, if an ML model is used to generate a configuration action on the basis of a received state identifier (as discussed in further detail below), the same model may be used for different second nodes, with the model being selected on the basis for example of the state identifier (or other state representation) reported by the second node. The model used may be updated on the basis of obtained success measures for a RAN operation performed for a given second node, and the updated model may be used for a different second node, so transferring the learning.

The first node may also receive, with the state representation, a validity parameter specifying a condition under which the received representation of the state of the second node is valid, as illustrated at 310d. The validity condition may for example be a time period or a threshold for one or more parameters, beyond which the state representation is no longer valid. The first node may confirm that the validity condition is met before performing subsequent actions, and may for example request an additional state representation if the validity condition is not met.

In step 312, the first node may obtain an ML model for use in generating a configuration action. The ML model may correspond to the received state representation, for example to the received state identifier. For example, if the state identifier or other state representation represents a mobility state of the second node, the first node may obtain an ML model for use with mobility states. For example, the first node may check in a memory for a trained ML model suitable for use with the received representation and/or compressed state, and may either retrieve a suitable ML model from the memory, or request and receive a suitable ML model from another node. In other examples, the first node may train an ML model for use in generating a configuration action. Such training may take place in a cloud environment, and may be performed before the method 300 is executed, and/or training or retraining may be triggered by receipt of a state representation. In further examples, the first node may obtain a suitable ML model before requesting the state representation from the second node.

As illustrated at 312, training a suitable ML model may comprise using a supervised learning method with a training data set comprising historical data for state representation of the second node, generated configuration action and obtained success measure, or reward, associated with the configuration action. As discussed above the state of the second node comprises a compressed representation of parameter values that describe at least one of a physical state, a radio environment or a physical environment experienced by the second node or experienced by at least one node that is connected to the communication network via the second node. The historical data for state representation of the second node may therefore comprise any of the representations and/or parameters discussed above with reference to the method 100. For example, parameters describing the physical state of the second node may include parameters describing battery power, memory, processing or computational capacity, sensor values obtained from sensors associated with the node (accelerometers, pressure sensors, light sensors, etc.). Parameters describing the physical environment experienced by the second node or a node connected via the second node may for example be obtained using cameras, lidars, GNSS, etc. and may include parameters such as geolocation, indoor/outdoor estimation, physical velocity or acceleration, nearby infrastructure detected (buildings, roads, etc.), nearby natural features detected (hills, mountains etc.), nearby detected antenna towers. Parameters describing the radio environment experienced by the second node or a node connected via the second node may include parameters such as signal power, interference and noise levels, detected presence of Line-of-sight components, delay-spread, angle-of-arrival etc. A success measure associated with a configuration action may for example comprise a success measure for the RAN operation configured according to the configuration action. FIG. 3d illustrates additional steps that may be performed as part of obtaining an ML model.

Referring to FIG. 3d, as illustrated at step 312i, the first node may initially check whether an ML model that corresponds the received state representation (for example the received state identifier) can be obtained. For example the first node may check whether a suitable ML model is stored in a memory, or may request a suitable ML model from another communication network node. If a suitable ML model is available, then the first node retrieves the ML model corresponding to the received state representation in step 312ii. If an ML model that corresponds to the received state identifier cannot be obtained, the first node may then check, at step 312iii, whether or not a threshold number of second nodes have reported the received state identifier. If at least a threshold number of second nodes have reported the received state identifier, then the first node may, in step 312iv, train, or request the training of, a new ML model for use in generating a configuration action from the received state identifier. If fewer than a threshold number of second nodes have reported the received state identifier, the first node may instruct the second node, at step 312v, to use a legacy reporting procedure for the RAN operation. The second node may then send a measurement report which can be used by the first node according to legacy procedures to manage configuration of the RAN operation. The check at step 312iii may thus be used to ensure that the computational expense of training a new ML model for a particular state is only incurred when this can be justified by the number of second nodes reporting such a state.

Referring again to FIG. 3b, in step 320, the first node uses the received state representation to generate a configuration action for the RAN operation. As discussed above, a configuration action may comprise any action which will in some manner configure the RAN operation, so controlling the manner in which the RAN operation is performed. As illustrated at 320a, generating the configuration action may comprise using a Machine Learning (ML) process to generate the configuration action as a function of the state of the second node, for example such that the machine learning process effectively maps the state and/or representation of the state of the second node to the configuration action that is to be generated. This may comprise inputting a representation of the state of the second node to an ML model trained for use in generating a configuration action. In some examples, additional inputs may also be used to generate the configuration action, for example through use of an ML process. For example, a state of the first node may also be used to generate the configuration action. Thus, the configuration action may be generated as a function of both the state of the second node and a state of the first node, using an ML process. A more detailed discussion of how the configuration action may be generated using an ML process is provided below, with reference to FIGS. 3e and 3f.

Referring now to FIG. 3e, using an ML process to generate the configuration action as a function of the state of the second node may comprise executing a Reinforcement Learning (RL) process at step 321i. Reinforcement learning is a type of machine learning in which the process continuously interacts with its environment and is given implicit and sometimes delayed feedback in the form of reward signals. Reinforcement learning performs short-term reward maximization but can also take short-time irrational decisions for long-term gains. Such processes try to maximize the expected future reward by exploiting already existing knowledge and exploring the space of actions in different network scenarios. As illustrated in FIG. 3e, executing an RL process in the context of step 320 of the method 300 may comprise using an ML model to predict a success measure for each of a plurality of possible configuration actions at step 322i. This may comprise inputting a representation of the state of the second node to the ML model for predicting a success measure for possible configuration actions at step 323i. The success measure for the configuration actions may be a predicted success measure of the RAN operation when configured according to the configuration actions. Such a success measure may be obtained during or following execution of the RAN operation, such that predicted values may be compared to obtained values for the success measure. Executing an RL process may then comprise selecting a configuration action based on the predicted success measures for possible actions. This may comprise using a selection function to select the configuration action based on the predicted success measures and an exploration component at step 324i. The exploration component may balance the value of exploiting existing knowledge regarding the success measures obtained for configuration actions against learning what success measures may be obtained for less explored possible actions. Finally, following execution of the RAN operation configured according to the configuration action, executing the RL process may comprise updating the ML model for predicting success measures at step 325i. As illustrated at steps 326i and 327i, updating the ML model may comprise obtaining a measure of success of the RAN operation configured in accordance with the generated configuration action and updating the ML model on the basis of the obtained measure of success.

Referring now to FIG. 3f, using an ML process to generate the configuration action as a function of the state of the second node may comprise executing an RL process at step 321ii. As illustrated in FIG. 3f, executing an RL process in the context of step 320 of the method 300 may also or alternatively comprise using an ML model to predict the probability of executing each of a plurality of possible configuration actions 322ii. This may comprise inputting a representation of the state of the second node to the ML model for predicting probabilities at step 323ii. Executing an RL process may then comprise selecting a configuration action based on the predicted probability for each possible action. This may comprise using a selection function to select the configuration action based on the predicted probabilities and an exploration component at step 324ii. The exploration component may balance the value of exploiting existing knowledge regarding the possible actions actions against learning what outcomes may be obtained for less explored possible actions. Finally, following execution of the RAN operation configured according to the configuration action, executing the RL process may comprise updating the ML model for predicting probabilities of execution at step 325ii. As illustrated at steps 326ii and 327ii, updating the ML model may comprise obtaining a measure of success, or reward, of the RAN operation configured in accordance with the generated configuration action and updating the ML model on the basis of the obtained measure of success.

Referring again to FIG. 3b, after generating the configuration action, the first node initiates configuration of the RAN operation in accordance with the generated configuration action in step 330. This may comprise configuring the RAN operation and/or transmitting the generated configuration action to another node for configuring of the RAN operation. Referring now to FIG. 3c, the first node then performs the RAN operation as configured in step 332.

In step 334, the first node obtains a measure of usefulness of the received representation of a state of the second node for configuration of the RAN operation. This may comprise obtaining a measure of success of the RAN operation. Success measures may be specific to the particular operation, and may for example represent some aspect of performance of the communication network. Network Key Performance Indicators may be useful measures of success of a RAN operation, for example representing how network performance was affected by the RAN operation, and enabling any improvement or degradation in network performance owing to the RAN operation to be identified. The first node may then update at least one of a process for using the received state representation to generate a configuration action for the RAN operation, or a configuration for receipt of the state representation, on the basis of the obtained measure of usefulness in step 336.

The process for using the received state representation to generate a configuration action for the RAN operation may be updated, as illustrated at 336a, by updating a weighting of the state against another parameter used to generate the configuration action, and/or by updating an ML process used to generate the configuration action as a function of the state of the second node. For example, if the state of the second node appears to have been less useful in generating an action, it may be less strongly weighted against other factors, including for example the state of the first node, in generating a future configuration action for the RAN operation.

A configuration for receipt of the state representation may be updated, as illustrated at 336b, by configuring a request for a further representation of a state of the second node with respect to the RAN operation. For example, if the second state appears to have been useful in generating a configuration action for the RAN operation, then a future request for a state relating to he RAN operation may specify a higher size limit for the state. Other options for configuring the request for a further representation of a state of the second node may include not sending the request at all, downwardly adjusting a size of the state that is requested, selecting a method for generating the state, selecting a method for representing the state, etc. This configuration of the request may be executed using the reporting parameter discussed above.

In step 338, the first node may forward the received state representation to another node of the communication network, either on request, as part of a separate exchange with the other node or in connection with a RAN procedure conducted with the other node.

FIGS. 4a to 4c show a flow chart illustrating process steps in a further example of method 400 for facilitating a RAN operation performed by a first node in a communication network. The method 400 may compliment either of the methods 100 and/or 300, and is performed by a second node in the communication network. The method 400 illustrates examples of how the steps of the method 200 may be implemented and supplemented to achieve the above discussed and additional functionality. As discussed above with reference to the method 200, the second node performing the method 400 may comprise a RAN of the communication network or a wireless device such as a UE operable to connect to the communication network. The first node may comprise a RAN node of the communication network.

Referring first to FIG. 4a, in a first step 402 of the method 400, the second node receives a request for a capability of the second node to provide a representation of its state with respect to a RAN operation performed by the first node. The capability request may specify the RAN operation in question, multiple RAN operations, or may be an open request for capabilities to provide a state representation with respect to any RAN operation.

In step 404, the second node transmits an indication of a capability of the second node to provide a representation of its state with respect to a RAN operation performed by the first node. The indication of capability may comprise a state identifier, RAN operations for which state representation is supported by the second node, methods supported for generating a state representation, etc. Options for capability signalling are discussed in further detail below with reference to example implementations of the present disclosure.

In step 406, the second node receives a request for a representation of a state of the second node with respect to the RAN operation. The request may be received from the first node or from another node that is operable to forward the state to the first node (for example in the case of forwarding between base stations or in a split-architecture scenario). As illustrated at 406a, the second node may receive, with the request for a representation of a state of the second node with respect to the RAN operation, a reporting parameter that configures reporting of the requested representation to the first node. The reporting parameter may for example specify at least one of a size of the compressed representation of parameter values that will comprise the state, a framework for identifying the state, a reporting periodicity for reporting an updated representation of the state to the first node, a trigger condition for reporting an updated representation of the state to the first node, and/or additional information to be included with the representation of the state. The second node may obtain, in step 408, an ML model for use in generating the state of the second node from parameter values for inclusion in the state. The ML model may for example comprise an Autoencoder, or

Principle Component Analysis model, as discussed in further detail below. Obtaining a model may comprise using a stored model, and/or downloading or otherwise obtaining periodic updates to the model. In some examples, the one or more reporting parameters may indicate what model should be used for generating the requested representation of the state of the second node.

Referring now to FIG. 4b, in step 409, the second node configures a process for generating the state of the second node on the basis of the reporting parameter. The second node may assemble parameters for inclusion in the state on the basis of a RAN operation identified in the request, and the assembling may be configured by one or more reporting parameters. In one example, as illustrated at 409a, the reporting parameter may specify a size of the compressed representation of parameter values that will comprise the state, and configuring a process for generating the state of the second node on the basis of the reporting parameter may consequently comprise configuring the process to generate a state of the size specified in the reporting parameter. For example, middle layer limitations for Autoencoders may be imposed, and/or a limit on the number of principal components for Principle Component Analysis. Other examples of configuring the process for generating the state representation may be envisaged, for example mapping the generated state to a state identifier in accordance with a framework specified in the reporting parameter.

In step 410, the second node generates a state of the second node with respect to the RAN operation. The state of the second node comprises a compressed representation of parameter values that describe at least one of a physical state, a radio environment or a physical environment experienced by the second node or by at least one node that is connected to the communication network via the second node. For example, if the second node is a RAN node, the state of the second node may comprise a compressed representation of parameters describing a radio and/or physical environment experienced by one or more wireless devices connected to the communication network via the second node.

As illustrated at 410a, the parameter values represented in the state of the second node may comprise values of parameters operable to impact execution of the RAN operation performed by the first node. Such parameters may in some examples include parameters that are not currently reported as part of existing communication network procedures, but may have an impact on the execution of the RAN operation, and so their inclusion in the state may assist in configuring the RAN operation so as to maximise a success measure of the operation. An example of such a parameter may include sensor readings from sensors such as accelerometers or light sensors mounted on the second node.

As illustrated at 410b and 410c, generating a state of the second node with respect to the RAN operation may comprise assembling parameter values for inclusion in the state at step 410b and generating a compressed representation of the parameter values using a Machine Learning (ML) process at step 410c. The second node may refer to information configured in the second node to determine which parameter values should be assembled for a state relating to a particular RAN operation. Assembling suitable parameters may comprise using measurements performed by the second node, sensor readings etc. and/or measurement values or other information received by the second node from other entities, including for example connected wireless devices such as UEs.

Generating the compressed representation of the parameter values using an ML process may comprise
reducing a dimensionality of the assembled parameter values using a trained ML model, which may comprise an encoder part of an Autoencoder (AE) or a model trained to execute a Principal Component Analysis (PCA) process. Autoencoders and PCA are discussed in greater detail below with reference to example implementations of the present disclosure.

In step 412, the second node prepares a representation of the generated state for transmission. This may comprise performing any one or more of mapping the generated state to a state identifier for transmission at step 412a, assembling the compressed representation for transmission at step 412b and/or computing a difference between the generated state and a previous state of the second node (delta encoding the representation) at step 412c. As discussed above with reference to the method 300, a state identifier for a state of a second node may comprise an identifier that is unique to a particular state. A particular state may be experienced by any one or more of a number of second nodes, and the same unique state identifier may be used to signify that particular state, regardless of the second node that is experiencing the state. Thus, for a given state, the same unique state identifier may identify the state for any second node in or connected to the communication network that is experiencing the state.

In step 414, the second node may generate a validity parameter specifying a condition under which the generated representation of the state of the second node is valid. The validity condition may for example be a time period or a threshold for one or more parameters, beyond which the state representation is no longer valid.

Referring now to FIG. 4c, in step 420, the second node transmits the prepared representation of the generated state to at least one of the first node or a node of the communication network that is operable to communicate with the first node. The second node may include the validity parameter (if generated) with the transmitted representation of the state of the second node, as illustrated at 420a.

As discussed above, a reporting parameter included with the request for a state of the second node may specify at least one of a reporting periodicity for reporting an updated representation of the state to the first node, or a trigger condition for reporting an updated representation of the state to the first node. In such examples, the second node may, on expiry of the reporting period or fulfilment of the trigger condition, generate an updated state of the second node and transmit, in step 422, a representation of the updated state to at least one of the first node or a node of the communication network that is operable to communicate with the first node.

In step 424, the second node obtains a measure of usefulness of the transmitted representation of a state of the second node for configuration of the RAN operation. As illustrated at 424a, this may comprise obtaining a measure of success of the RAN operation. In step 426, the second node may update at least one of a process for generating the state of the second node or a parameter included with the transmitted representation of the generated state on the basis of the obtained measure of usefulness.

FIGS. 1 to 4c discussed above provide an overview of methods which may be performed according to different examples of the present disclosure. The methods involve signalling a representation of a state of a second node, which state may be used by a first node to generate a configuration action for a RAN operation performed by the first node. The state of the second node compressed representation of parameter values, and the first node may have no prior knowledge of the meaning of the state, but may learn to use the representation of the state to generate a configuration action for the RAN operation. There now follows a detailed discussion of how different process steps illustrated in FIGS. 1 to 4c and discussed above may be implemented.

### Signalling of Second Node Capabilities (Steps 302, 304, 402, 404)

The second node may signal, for example on request by the first node, its capabilities for generating a representation of a state of the second node with respect to one or more RAN operations. As discussed above, in some examples, the capabilities signalled may comprise a state representation identifier. The identifier could be shared among a plurality of devices if a device manufacture uses the same method in creating a certain state representation for a particular RAN operation in all its devices. For example, all smartphone devices from a particular manufacture may use the same method (e.g. autoencoders) to compress interference information into a state, when the first node requests a state related to link-adaptation. A plurality of first node sin the network could then use the same RL model for each of those devices to translate the UE reported state into a configuration action for the link-adaptation RAN operation (e.g. setting mobility parameters)

The capabilities could also or alternatively include the supported radio-network operations for which the second node supports state based signalling.

In one example, a capability report from the second node may indicate that the second node is capable of using more than one method to create a state representation. In addition, the capability report may indicate that different methods are available in association with different RAN operations. The capability report of the second node may further indicate one or more state-size capabilities (e.g. expressed in number of bits that represents the state) that can be used to represent a state, such as maximum or minimum state size. The state-size capability may additionally be associated to one or more RAN operations. The second node may therefore be capable of using different state representation methods as well as providing different state-size representations for different radio network operations.

Upon receiving the capability report from the second node, the first node can configure the second node to report a state representation associated with a specific RAN operation using, for instance, one of the state representation methods available at the second node. The first node may further configure the second node with a preferred state-size representation associated with a certain RAN operation based on the second node's capability report.

Requesting and receiving a state of the second node (steps 306, 310, 406, 420)

As discussed above, the first node can request a state representation from the second node that relates to a particular RAN operation. Examples of such RAN operations include:
Link adaptation (LA): the second node can compress information on parameters that can for example affect the link-adaptation in a neighbouring node. For example the number of connected UEs and the traffic characteristics of such UEs. The node could signal qualities of the connected UEs. If the second node is a wireless device such as a UE, it could compress information related to its environment, for example the experienced interference. In some examples, the UE could compress the information into a CQI estimate.
Scheduling: similarly to LA; the second network node can compress the state of the scheduling decisions in upcoming time-frames into a compact state representation.
TDD configurations
Power control
Beamforming selection
Link-adaptation settings
Traffic/load information
Radio resource management
Mobility operations
Random access operation (e.g., RACH reports)
Dual or multi-connectivity operation
Beamforming operations
RRC state handling
Inter-RAT operation
Carrier aggregation
Transmission mode selection
Energy savings operations/settings

The first node can request a state using the following example ASN1 format.

```
--ASN1START
State-information-request ::= SEQUENCE {
  Radio-network-operation ENUMERATED {
                                Link-adpatation, scheduling,
beamforming,  mobility, load-balancing,...,}
  state-size Integer OPTIONAL, -- Cond Setup
  state-reporting-periodicity Integer OPTIONAL, -- Cond Setup
  state-reporting-trigger boolean OPTIONAL, -- Cond Setup
}
--ASN1END
```

The first network node could also include information on the size of the compressed state, using a reporting parameter as discussed above. A large size can enable more precise decisions, at a cost of more data transmitted. The selection of what size of representation to request can be based on the performance of the method. For example, the first node can request to increase the resolution if multiple actions for a given state give similar rewards in a reinforcement learning framework. The state-size can comprise the number of floating points allowed for the state feedback from the second node.

The periodicity in which the second node reports the state can also be selected based on the radio-network operation. For example, based on the frequency with which a scheduling decision is taken, or a link-adaptation selection is made.

The state information can in another example be requested to be triggered when the state has changed more than a certain threshold; for example if the Euclidian distance of the new state is larger by a certain threshold than a previously reported state. In another example, the state information can be requested or triggered when one or more Key Performance Indicators (KPIs) have changed by more than a threshold amount. The KPI change may also be associated to a measuring interval. The KPI change may additionally be associated to the first node, to the second node or to the network, or a plurality of first nodes, second nodes or combination thereof within the network. Examples of KPIs may include one or more of:
Data rate or throughput
Data latency
Block error rate
Packet error rate
Energy consumption

The second network node can respond with the following example ASN1 format:

```
--ASN1START
State-information-respond ::= SEQUENCE {
  Radio-network-operation ENUMERATED {
                                Link-adpatation, scheduling,
beamforming, mobility,  load-balancing,...,}
  state SEQUENCE {Float},
  validity-timer Integer, Optional
--ASN1END
```

The signalling response from the second node may cover the time when the reported state is valid. In the case of beamforming, this might correspond to the coherence time of the channel. In the case of scheduling, this might correspond to the time at which the state represents the decisions taken by the scheduler. The response method could in one embodiment comprise the difference in the current state, in respect to a previous state (delta encoding).

### Generating a State Representation (Steps 409, 410, 412)

The second network node generates a state that will represent information that it considers relevant or useful for a certain RAN operation. For example, in case of link-adaptation, a second node in the form of a UE may seek to encode information that is related to the experienced interference and noise levels, and additional features that might be relevant in order to select a proper MCS at the network. The UE can also use other input that is not possible to include in the framework for Long Term Evolution/ New Radio (LTE/NR). For example the UE could include information of mobility from its sensors (accelerometers, light-sensors, etc.). This would enable the UE to also include some mobility information in the context.

Similarly, for handover, a second node in the form of a UE may seek to encode as much information of its surroundings as possible, in order to improve the handover decisions and its mobility. The state can be based on information such as location, indoor/outdoor estimate, sensors etc.

Methods that can be used in order to create a compact state space representation include Autoencoders (AE) and principal component analysis (PCA). An AE is a type of machine learning process that may be used to learn efficient data representations, that is to concentrate data. AE are trained to take a set of input features and reduce the dimensionality of the input features, with minimal information loss. An AE is divided into two parts, an encoding part or encoder and a decoding part or decoder. The encoder and decoder may comprise, for example, deep neural networks comprising layers of neurons. An encoder successfully encodes or compresses the data if the decoder is able to restore the original data stream with a tolerable loss of data. One example of an AE comprising an encoder/decoder for CSI compression is shown in Figure the absolute values of the Channel impulse response (CIR) are compressed to a code, and the code is decoded to reconstruct the measured CIR. In examples of the present disclosure, the second node may use AE to generate a compressed representation of values of parameters to be included in the state. The compressed representation, or an identifier of the representation can then be transmitted to the first node. A similar result may be achieved using PCA to generate the compressed representation.

Rather than also transmitting the decoder part of the AE, or suitable PCA information, so that the first node can reconstruct the compressed data, the first node instead directly uses the compressed representation to generate a configuration action for the RAN operation. For example, using RL methods, the first node can learn a prediction function that predicts, on the basis of the state representation, what success measures for the RAN operation can be obtained using different configuration actions for the operation. A selection function can then select a suitable configuration action on the basis of the predicted success measures. In this manner, the RL process in the first node effectively maps the compressed state representation directly to a configuration action for the RAN operation, without seeking to first decompress or decode the information in the state. As discussed in further detail below, an advantage of this arrangement is that the first node does not need to know what parameters are included in the state representation, and no additional standardisation is needed in order to include an additional parameter into a state representation for a particular RAN operation, the RL process in the first node can simply adapt and learn how to interpret the compressed state representation including the new parameter. This also enables parameters that are not currently exchanged according to LTE/NR processes, but which may provide relevant information for particular RAN operations, to be taken into account.

The state size required by the first node, that is the number of bits used to represent the state, may affect the layout of the compression method. For example, middle layer limitations in case of an AE, or the number of principal components in case of PCA, may be imposed according to the required state size.

### Configuring and Performing RAN Operation (Steps 330, 332)

The first network node receives the representation of the compressed state of second node. If the first node, or its network, has no model built or trained for generating a RAN operation configuration action for a received state, it can learn the mapping of a state to an optimal action for a RAN operation. The first node could for example use reinforcement learning (RL) techniques to learn the best action for the received state information. The optimal configuration action generated by an agent implementing the RL technique could be based on both the internal state at the first node, and the received state from the second node. For example, if a UE reported state covers LA, the first node can include information such as the Block Error Rate (BLER) of previous transmissions when selecting the optimal configuration action (what modulation and coding scheme (MCS) to use).

In another example, if the first node has a previously trained RL model for a received state identifier available in an accessible memory, it can use that model for the RAN operation. The state identifier could for example be the same for all devices produced by a particular UE manufacturer. In a further example, the first node can request information on the mapping of state representation to RAN operation configuration action from a third network node. For example the first node can request a mapping from a node that has or may have hosted in the past UEs with a similar state identifier. The third network node could comprise a server node (e.g. Mobility Management Entity (MME)), or another RAN node.

### Evaluating Usefulness (Steps 334, 336, 424, 426)

The first node, or functionality associated with the first node, can evaluate the usefulness of the received state by correlating it with a KPI associated with the RAN operation. For example, in the case of LA, the first network node can correlate the received state from a neighbouring base station node with the throughput experienced by the users in the first node. If there is a high correlation, suggesting configuration actions for LA that have been generated using the state have led to improved performance, then the first node can request to increase the state representation size, as the increased cost of data transmission is justified by the usefulness of the state representation in configuring LA. If there is a low correlation, the network can stop receiving state information from a certain neighbouring base station node, or reduce the size of the received state representation. The usefulness measure could in some examples be signalled to the second node, which could use the measure to create a new state representation for a certain RAN operation. The second node could flag to the first node whenever it has changed its state representation. If the second node is a UE, the UE may in some examples implicitly know the usefulness of its reported state, as it can correlate the reported state with its own experienced throughout, mobility performance or other measure for evaluating the success of the RAN operation, and consequently the usefulness of the state representation for generating configuration actions for the RAN operation.

### Forwarding State Representation Among Network Nodes

In one example, the state representation received from a second node, which may be a wireless device such as a UE or a RAN node, may be forwarded to another node in the communication network. Several different scenarios can be envisaged:

In a split architecture:
A Distributed Unit (DU) requests a state from a connected UE, receives the state from the UE and forwards the state to its corresponding Centralised Unit (CU).
A CU requests a state from a first DU (the state could be a state produced by the first DU or by a UE connected to the first DU), the CU receives the state from the first DU and forwards it to a second DU.
A first CU requests a state from a DU (the state could be a state produced by the DU or by a UE connected to the first DU), the first CU receives the state from the DU and forwards it to a second CU.

In non-split architecture
A first base station (e.g., a baseband unit) requests a state from a UE, receives the state from the UE and forwards it a second base station.

As discussed above, the methods 100 and 300 may be performed by a first node, and the present disclosure provides a first node that is adapted to perform any or all of the steps of the above discussed methods. The first node may be a physical or virtual node, and may for example comprise a virtualised function that is running in a cloud, edge cloud or fog deployment. In some examples, the first node may comprise a RAN node. The RAN node may itself be divided between several logical and/or physical functions, and any one or more parts of the first node may be instantiated in one or more logical or physical functions of a RAN network node.

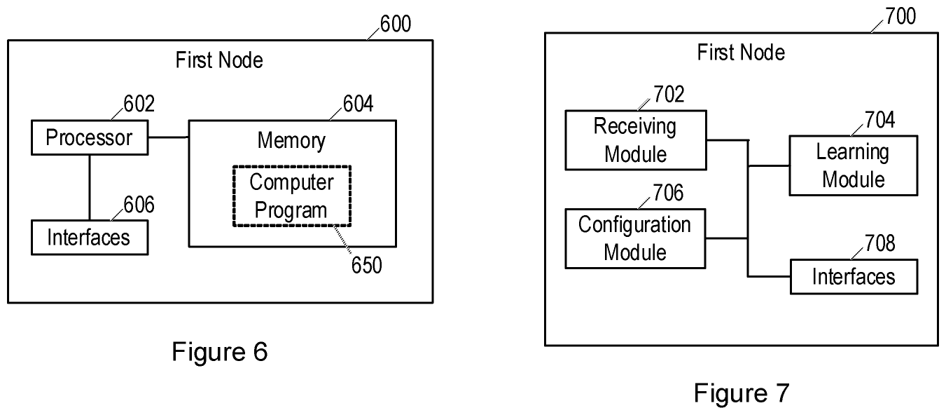

FIG. 6 is a block diagram illustrating an example second node 1300 which may implement the method 100 and/or 300, as elaborated in FIGS. 1 and 3a to 3d, according to examples of the present disclosure, for example on receipt of suitable instructions from a computer program 650. Referring to FIG. 6, the first node 600 comprises a processor or processing circuitry 602, and may comprise a memory 604 and interfaces 606. The processing circuitry 602 is operable to perform some or all of the steps of the method 100 and/or 300 as discussed above with reference to FIGS. 1 and 3a to 3d. The memory 604 may contain instructions executable by the processing circuitry 1302 such that the first node 600 is operable to perform some or all of the steps of the method 100 and/or 300, as elaborated in FIGS. 1 and 3a to 3d. The instructions may also include instructions for executing one or more telecommunications and/or data communications protocols. The instructions may be stored in the form of the computer program 650. In some examples, the processor or processing circuitry 602 may include one or more microprocessors or microcontrollers, as well as other digital hardware, which may include digital signal processors (DSPs), special-purpose digital logic, etc. The processor or processing circuitry 602 may be implemented by any type of integrated circuit, such as an Application Specific Integrated Circuit (ASIC), Field Programmable Gate Array (FPGA) etc. The memory 604 may include one or several types of memory suitable for the processor, such as read-only memory (ROM), random-access memory, cache memory, flash memory devices, optical storage devices, solid state disk, hard disk drive etc.

FIG. 7 illustrates functional modules in another example of first node 700 which may execute examples of the methods 100 and/or 300 of the present disclosure, for example according to computer readable instructions received from a computer program. It will be understood that the modules illustrated in FIG. 7 are functional modules, and may be realised in any appropriate combination of hardware and/or software. The modules may comprise one or more processors and may be integrated to any degree.

Referring to FIG. 7, the first node 700 is for managing a RAN operation performed by the first node in a communication network that comprises a RAN. The first node 700 comprises a receiving module 702 for receiving a representation of a state of a second node with respect to the RAN operation, wherein the state of the second node comprises a compressed representation of parameter values that describe at least one of a physical state, a radio environment or a physical environment experienced by the second node or experienced by at least one node that is connected to the communication network via the second node. The first node 700 further comprises a learning module 704 for using the received state representation to generate a configuration action for the RAN operation, and a configuration module 706 for initiating configuration of the RAN operation in accordance with the generated configuration action. The first node 700 may further comprise interfaces 708, which may be operable to facilitate communication with a second node, and/or with other communication network nodes, over suitable communication channels.

As discussed above, the methods 200 and 400 may be performed by a second node, and the present disclosure provides a second node that is adapted to perform any or all of the steps of the above discussed methods. The second node may be a physical or virtual node, and may for example comprise a virtualised function that is running in a cloud, edge cloud or fog deployment. In some examples, the second node may comprise a RAN node. The RAN node may itself be divided between several logical and/or physical functions, and any one or more parts of the second node may be instantiated in one or more logical or physical functions of a RAN network node. In other examples, the second node may comprise a wireless device such as a UE.

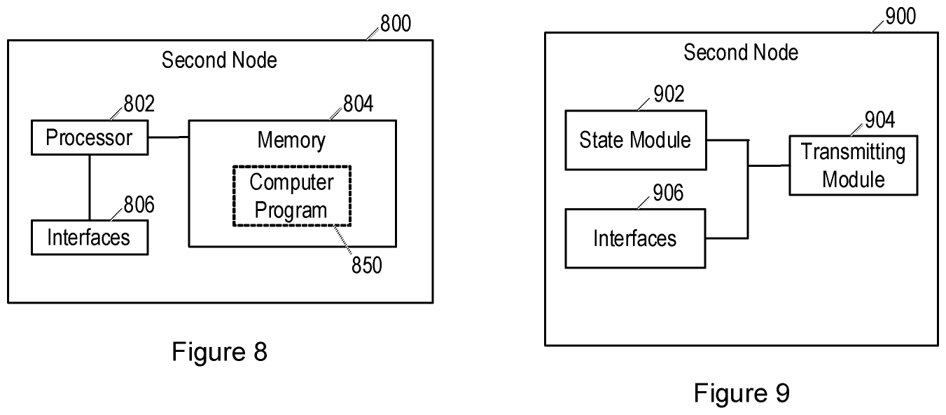

FIG. 8 is a block diagram illustrating an example second node 800 which may implement the method 200 and/or 400, as elaborated in FIGS. 2 and 4a to 4c, according to examples of the present disclosure, for example on receipt of suitable instructions from a computer program 850. Referring to FIG. 8, the second node 800 comprises a processor or processing circuitry 802, and may comprise a memory 804 and interfaces 806. The processing circuitry 802 is operable to perform some or all of the steps of the method 200 and/or 400 as discussed above with reference to FIGS. 2 and 4a to 4c. The memory 804 may contain instructions executable by the processing circuitry 802 such that the second node 800 is operable to perform some or all of the steps of the method 200 and/or 400, as elaborated in FIGS. 2 and 4a to 4c. The instructions may also include instructions for executing one or more telecommunications and/or data communications protocols. The instructions may be stored in the form of the computer program 850. In some examples, the processor or processing circuitry 802 may include one or more microprocessors or microcontrollers, as well as other digital hardware, which may include digital signal processors (DSPs), special-purpose digital logic, etc. The processor or processing circuitry 802 may be implemented by any type of integrated circuit, such as an Application Specific Integrated Circuit (ASIC), Field Programmable Gate Array (FPGA) etc. The memory 804 may include one or several types of memory suitable for the processor, such as read-only memory (ROM), random-access memory, cache memory, flash memory devices, optical storage devices, solid state disk, hard disk drive etc.

FIG. 9 illustrates functional modules in another example of second node 900 which may execute examples of the methods 200 and/or 400 of the present disclosure, for example according to computer readable instructions received from a computer program. It will be understood that the modules illustrated in FIG. 9 are functional modules, and may be realised in any appropriate combination of hardware and/or software. The modules may comprise one or more processors and may be integrated to any degree.

Referring to FIG. 9, the second node 900 is for facilitating a RAN operation performed by a first node in a communication network that comprises a RAN. The second node 900 comprises a state module 902 for generating a state of the second node with respect to the RAN operation, wherein the state of the second node comprises a compressed representation of parameter values that describe at least one of a physical state, a radio environment or a physical environment experienced by the second node or experienced by at least one node that is connected to the communication network via the second node. The second node further comprises a transmitting module 904 for transmitting a representation of the generated state to at least one of the first node or a node of the communication network that is operable to communicate with the first node. The second node 900 may further comprise interfaces 906 which may be operable to facilitate communication with a first node or other communication network node over suitable communication channels.

### Example Use Cases

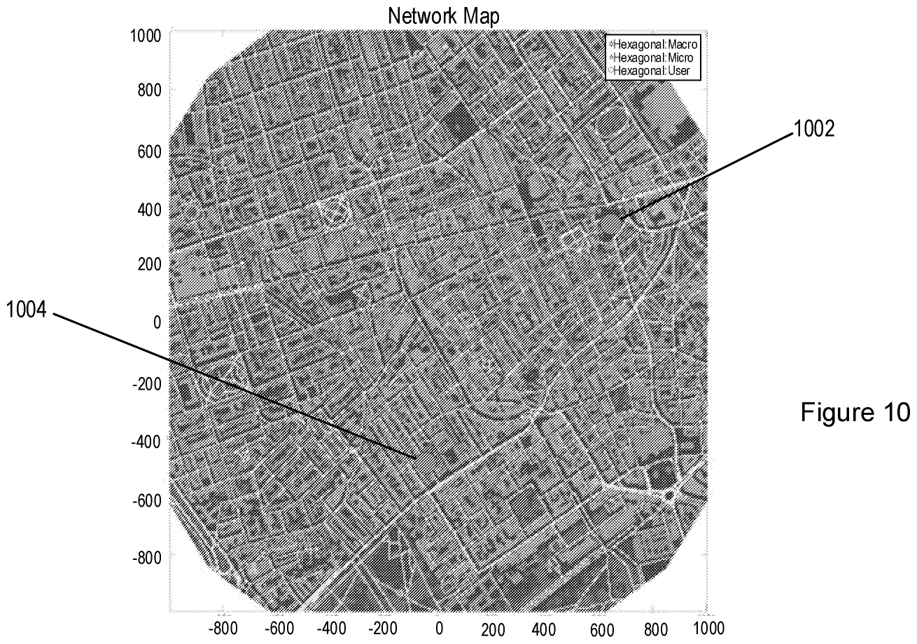

The two examples illustrated below demonstrate a scenario in which a UE is conducting measurements on reference signals from an NR-system. These measurements are compressed onto 2-floating point values, denoted enc1, enc2. In one example, the UE may report its measurements uncompressed, and the serving base station of the UE may act as a second node, compressing the received measurements to generate a state representation, and providing this state representation to another RAN node acting as a first node according to the present disclosure. This is illustrated in Example 1 below. In another example, the UE may itself be a second node according to the present disclosure, and so may generate a state by compressing its signal measurements and reporting these to a relevant first node (which may be its serving base station). This is illustrated in Example 2 below. Both examples relate to a simulation, illustrated in FIG. 10, in which UEs are connected to a first base station 1002. FIG. 10 illustrates a deployment plot of an urban area served by a communication network. The communication network comprises macro cells 1002 and 1004 deployed at 3.5GHz, and micro cells deployed at 28 GHz.

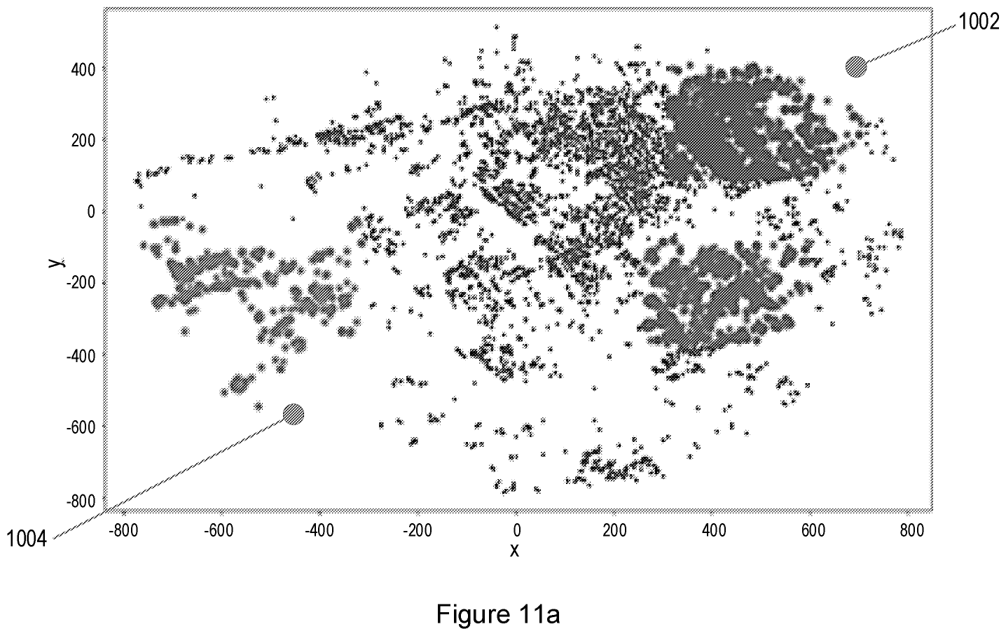

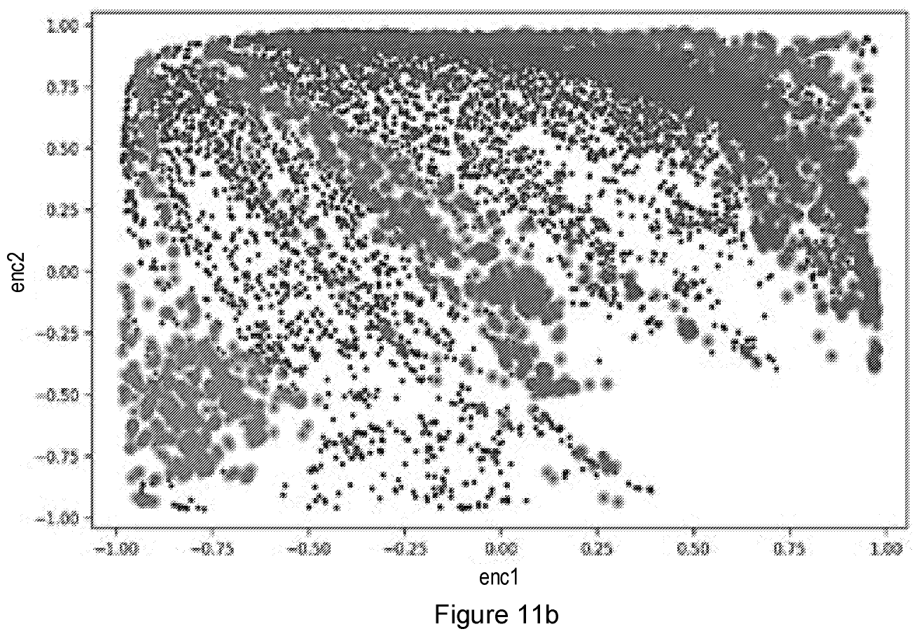

FIGS. 11a and 11b illustrate different areas served by RAN node 1002, and show how they map onto an encoded or compressed state. The compressed state is generated by feeding the mobility reference signals (SSBs) detectable by UEs into an auto-encoder with a size-2 middle layer. FIG. 11a is a position plot of UEs connected to node 1102, and FIG. 11b illustrates a corresponding encoded representation of the mobility reference signal measurements obtained by the UEs. In FIG. 11, the encoded version of the mobility reference signals is shown to map onto different geographical areas. This illustrates how a compressed state can map onto different geographical areas, demonstrating the possibility of compressing complex relations in an environment onto a few encoded values. In this case, mapping mobility signals from 57 macro-cells on 3.5 GHz carrier onto two encoded values.

### EXAMPLE 1

### First and Second Network Nodes are RAN Nodes

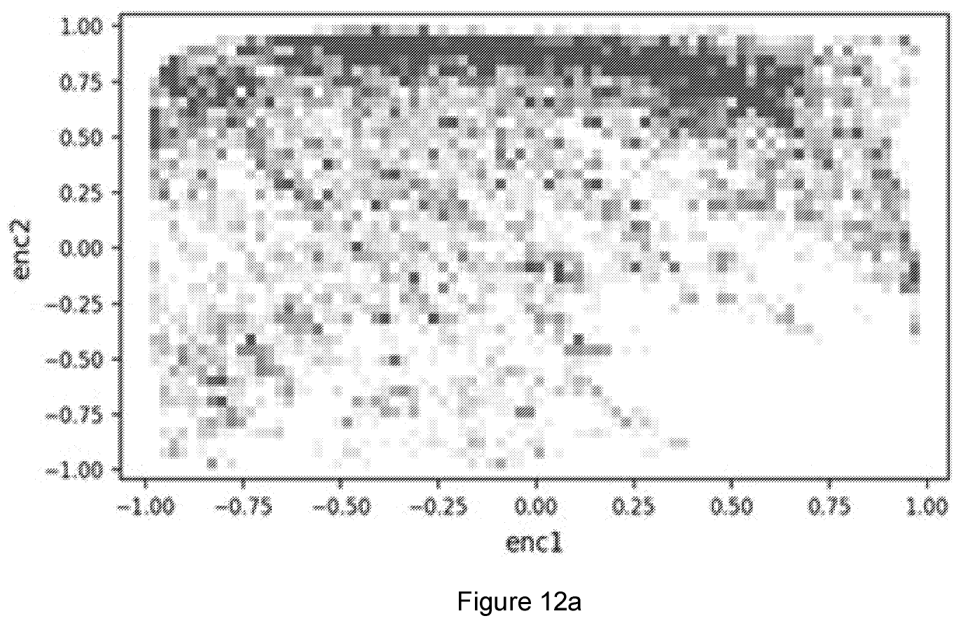

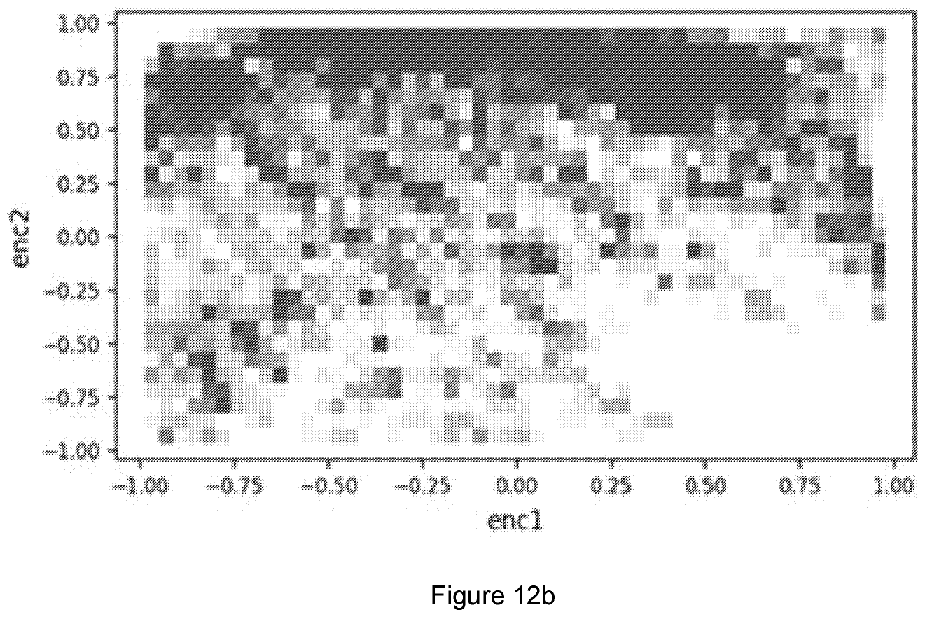

In this example, the first node is macro RAN node 1004 of FIG. 11, and the second node is macro RAN node 1002. The first node 1004 intends to set link-adaptation parameters for its served UEs. The first node 1004 requests a state representation for a state of the second node 1002 relating to the LA operation. The second node 1002 creates a state based on information related to an interference estimate. The second node 1002 could for example use the encoded mobility measurements of its connected UEs, and aggregate all encoded values onto an image representation, which is the state representation that is signalled to the first node 1004 and illustrated in FIGS. 12a and 12b. The dark colour indicates the number of UEs in each bin from 0 to 100. FIG. 12a illustrates a state comprising a detailed encoding of information related to LA, and FIG. 12b illustrates a sparser encoding. It may be expected that the UEs highlighted on the left of FIGS. 11a and 11b create more interference for the first node 1002. The first node 1004 can learn that when the value of the state-area in bottom left of FIGS. 12a and 12b 5 is high, it can expect more interference and configure the LA correspondingly. The first node 1004 can also increase or decrease the resolution of the received state representation (the detail of the encoding) based on the cost vs benefit of the information, as measured by the success of the LA operation.

### EXAMPLE 2

### First Node is a RAN Node and Second Node is a UE

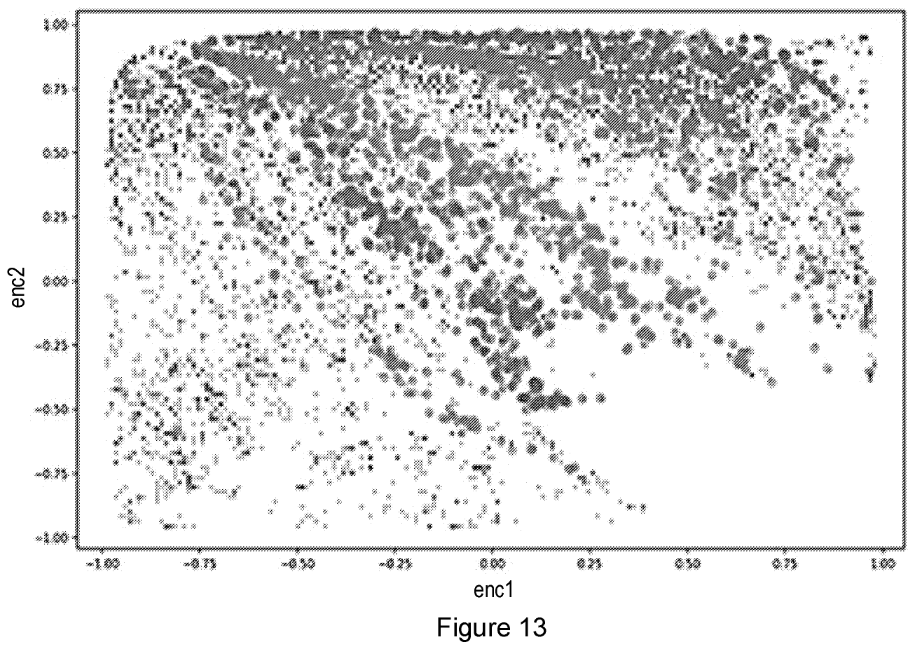

In this example, the encoding of the reference signal measurements is done at the UE side, with a UE acting as second node and having the capability to encode multiple reference signal measurements into a state. In this example, the network can learn for example beamforming decisions based on the state. An example of how the optimal beam-selection can depend on the UE reported state for two different example beams is illustrated in FIG. 13. It will be appreciated that the UEs in this example are assumed to generate the same state for a certain reference signal measurement. The first node can choose to increase the state size to get better representation, as only 2 encoded bits may not be sufficient when selecting among a high number of beams. FIG. 13 illustrates how the first node can learn the optimal precoder for each reported state representation. In the example If FIG. 13, signal quality measurements on the mobility beams are used to represent the state, however, the channel impulse response can also or alternatively be used to generate an efficient state for beamforming decisions.

### Predicting Coverage on Another Carrier Example

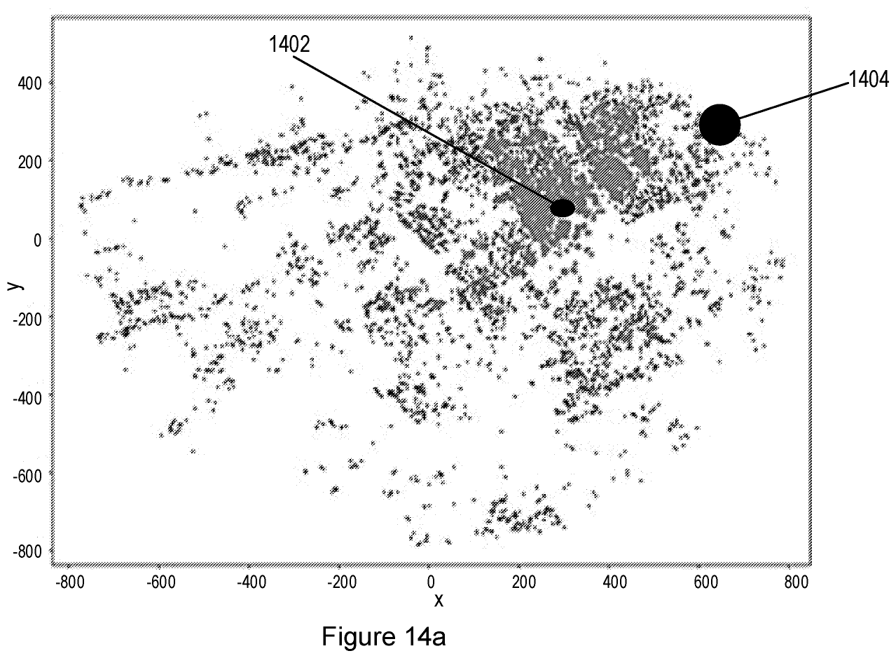

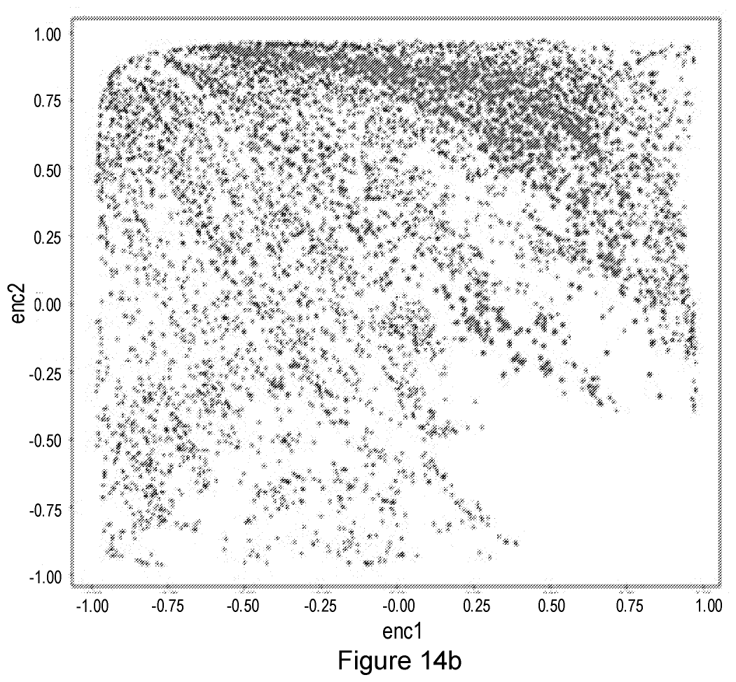

FIGS. 14a and 14b illustrate how a state representation can be mapped to having coverage on a node on another frequency. The highlighted UEs in FIG. 14a are UEs that are in coverage of the node 1402, operating at a 28 GHz carrier. FIG. 14b shows how those UEs can be encoded into a state for use in configuring a Handover operation at node 1404. The node 1404 can use machine learning to find the states that correlate with having coverage on the node 1402 (finding the highlighted UEs).

As demonstrated by the above discussion, examples of the present disclosure provide a framework for the signalling and use of a “compressed state”, wherein the compressed state comprises a compressed representation of parameter values. The parameter values describe at least one of a physical state, a radio environment or a physical environment experienced by a second node or experienced by at least one node that is connected to a communication network via the second node, for example if the second node is a Radio Access node such as a base station. A representation of the compressed state is received by a first node, which may have no prior knowledge of the meaning of the compressed state, other than in certain examples that the compressed state relates to a particular RAN operation. The first node can use the compressed state to generate a configuration action for the RAN operation, for example using Reinforcement Learning (RL).

Examples of the present disclosure enable the use of ML, both at the first and second node, to optimise a certain RAN operation. Key advantages offered by examples of the present disclosure may include reduced signalling overhead, reduced standardisation requirements, and improved performance.

### Reduced Signalling Overhead

Second network node can compress information related to a certain RAN operation into a state, and does not need to expend signalling resources describing the meaning of the state. Examples of the present disclosure enable adjusting the state information size based on the RAN operation, allowing for identifying the optimal reporting size for each operation. The communication network does not need to download models to the UE or radio-access node, offering further signalling overhead reduction.

### Reduced Standardisation Overhead

Information to be reported for different RAN procedures is currently defined in standards. For example, in LA, a UE is required to translate its experienced environment into CQI values. Addition of a new parameter for reporting in relation to a RAN procedure therefore requires amendment to the relevant standards. In contrast, any new beneficial information can be added into a state representation relating to a RAN operation when it is identified or becomes available, without requiring any changes to the relevant standards. For example, if a UE is upgraded to estimate a better link-adaptation state, then the UE can include this information in its generated state and simply signal an indication that the information included in its state representation has changed. Examples of the present disclosure thus reduce the need for standardisation efforts in specifying semantics for a particular radio-network operation.

In classical rule-based processes, the input to the process needs to be described in detail in order to develop and deploy the process. In contrast, according to examples of the present disclosure, an ML process running at the first node can learn the meaning of new input data used in generating a state representation at a second node. This both reduces the need to create a framework to describe the input data, and reduces the signalling needed to describe the input.

### Improved Performance

The second node can use any method and information to generate the compressed state representation, and the first node can use RL to learn the best configuration action for a certain RAN operation. A UE could for example include its geo-location and velocity information into a state related to mobility actions, enabling an overall mobility decision that offers improved robustness and performance, from which the UE can benefit. It will be appreciated that a UE can compress its geolocation into a state, thus ensuring privacy by not revealing the actual geolocation of the UE, while still benefitting from the inclusion of this information into the compressed state.

It will be appreciated that examples of the present disclosure may be virtualised, such that the methods and processes described herein may be run in a cloud environment.

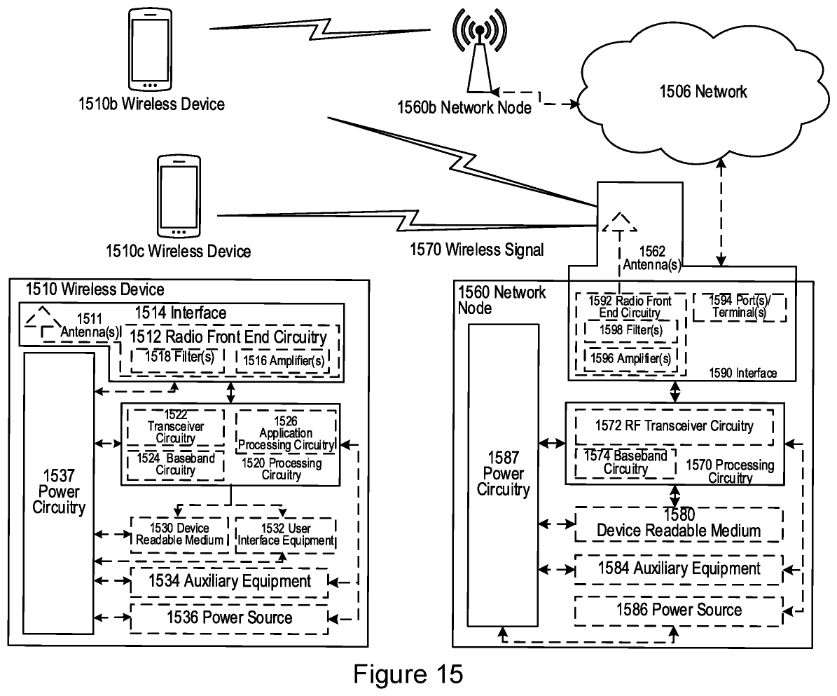

Although the subject matter described herein may be implemented in any appropriate type of system using any suitable components, the embodiments disclosed herein are described in relation to a wireless network, 15 such as the example wireless network illustrated in FIG. 15. For simplicity, the wireless network of FIG. only depicts network 1506, network nodes 1560 and 1560b, and WDs 1510, 1510b, and 1510c. In practice, a wireless network may further include any additional elements suitable to support communication between wireless devices or between a wireless device and another communication device, such as a landline telephone, a service provider, or any other network node or end device. Of the illustrated components, network node 1560 and wireless device (WD) 1510 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (Wi Max), Bluetooth, Z-Wave and/or ZigBee standards.

Network 1506 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1560 and WD 1510 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 15, network node 1560 includes processing circuitry 1570, device readable medium 1580, interface 1590, auxiliary equipment 1584, power source 1586, power circuitry 1587, and antenna 1562. Although network node 1560 illustrated in the example wireless network of FIG. 15 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1560 are depicted as single boxes located within a larger box, or nested within multiple boxes, in practice, a network node may comprise multiple different physical components that make up a single illustrated component (e.g., device readable medium 1580 may comprise multiple separate hard drives as well as multiple RAM modules).

Similarly, network node 1560 may be composed of multiple physically separate components (e.g., a NodeB component and a RNC component, or a BTS component and a BSC component, etc.), which may each have their own respective components. In certain scenarios in which network node 1560 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1560 may be configured to support multiple radio access technologies (RATs). In such embodiments, some components may be duplicated (e.g., separate device readable medium 1580 for the different RATs) and some components may be reused (e.g., the same antenna 1562 may be shared by the RATs). Network node 1560 may also include multiple sets of the various illustrated components for different wireless technologies integrated into network node 1560, such as, for example, GSM, WCDMA, LTE, NR, WiFi, or Bluetooth wireless technologies. These wireless technologies may be integrated into the same or different chip or set of chips and other components within network node 1560.

Processing circuitry 1570 is configured to perform any determining, calculating, or similar operations (e.g., certain obtaining operations) described herein as being provided by a network node. These operations performed by processing circuitry 1570 may include processing information obtained by processing circuitry 1570 by, for example, converting the obtained information into other information, comparing the obtained information or converted information to information stored in the network node, and/or performing one or more operations based on the obtained information or converted information, and as a result of said processing making a determination.

Processing circuitry 1570 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1560 components, such as device readable medium 1580, network node 1560 functionality. For example, processing circuitry 1570 may execute instructions stored in device readable medium 1580 or in memory within processing circuitry 1570. Such functionality may include providing any of the various wireless features, functions, or benefits discussed herein. In some embodiments, processing circuitry 1570 may include a system on a chip (SOC).

In some embodiments, processing circuitry 1570 may include one or more of radio frequency (RF) transceiver circuitry 1572 and baseband processing circuitry 1574. In some embodiments, radio frequency (RF) transceiver circuitry 1572 and baseband processing circuitry 1574 may be on separate chips (or sets of chips), boards, or units, such as radio units and digital units. In alternative embodiments, part or all of RF transceiver circuitry 1572 and baseband processing circuitry 1574 may be on the same chip or set of chips, boards, or units.

In certain embodiments, some or all of the functionality described herein as being provided by a network node, base station, eNB or other such network device may be performed by processing circuitry 1570 executing instructions stored on device readable medium 1580 or memory within processing circuitry 1570. In alternative embodiments, some or all of the functionality may be provided by processing circuitry 1570 without executing instructions stored on a separate or discrete device readable medium, such as in a hard-wired manner. In any of those embodiments, whether executing instructions stored on a device readable storage medium or not, processing circuitry 1570 can be configured to perform the described functionality. The benefits provided by such functionality are not limited to processing circuitry 1570 alone or to other components of network node 1560, but are enjoyed by network node 1560 as a whole, and/or by end users and the wireless network generally.

Device readable medium 1580 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1570. Device readable medium 1580 may store any suitable instructions, data or information, including a computer program, software, an application including one or more of logic, rules, code, tables, etc. and/or other instructions capable of being executed by processing circuitry 1570 and, utilized by network node 1560. Device readable medium 1580 may be used to store any calculations made by processing circuitry 1570 and/or any data received via interface 1590. In some embodiments, processing circuitry 1570 and device readable medium 1580 may be considered to be integrated.

Interface 1590 is used in the wired or wireless communication of signalling and/or data between network node 1560, network 1506, and/or WDs 1510. As illustrated, interface 1590 comprises port(s)/terminal(s) 1594 to send and receive data, for example to and from network 1506 over a wired connection. Interface 1590 also includes radio front end circuitry 1592 that may be coupled to, or in certain embodiments a part of, antenna 1562. Radio front end circuitry 1592 comprises filters 1598 and amplifiers 1596. Radio front end circuitry 1592 may be connected to antenna 1562 and processing circuitry 1570. Radio front end circuitry may be configured to condition signals communicated between antenna 1562 and processing circuitry 1570. Radio front end circuitry 1592 may receive digital data that is to be sent out to other network nodes or WDs via a wireless connection. Radio front end circuitry 1592 may convert the digital data into a radio signal having the appropriate channel and bandwidth parameters using a combination of filters 1598 and/or amplifiers 1596. The radio signal may then be transmitted via antenna 1562. Similarly, when receiving data, antenna 1562 may collect radio signals which are then converted into digital data by radio front end circuitry 1592. The digital data may be passed to processing circuitry 1570. In other embodiments, the interface may comprise different components and/or different combinations of components.

In certain alternative embodiments, network node 1560 may not include separate radio front end circuitry 1592, instead, processing circuitry 1570 may comprise radio front end circuitry and may be connected to antenna 1562 without separate radio front end circuitry 1592. Similarly, in some embodiments, all or some of RF transceiver circuitry 1572 may be considered a part of interface 1590. In still other embodiments, interface 1590 may include one or more ports or terminals 1594, radio front end circuitry 1592, and RF transceiver circuitry 1572, as part of a radio unit (not shown), and interface 1590 may communicate with baseband processing circuitry 1574, which is part of a digital unit (not shown).

Antenna 1562 may include one or more antennas, or antenna arrays, configured to send and/or receive wireless signals. Antenna 1562 may be coupled to radio front end circuitry 1590 and may be any type of antenna capable of transmitting and receiving data and/or signals wirelessly. In some embodiments, antenna 1562 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MI MO. In certain embodiments, antenna 1562 may be separate from network node 1560 and may be connectable to network node 1560 through an interface or port.

Antenna 1562, interface 1590, and/or processing circuitry 1570 may be configured to perform any receiving operations and/or certain obtaining operations described herein as being performed by a network node. Any information, data and/or signals may be received from a wireless device, another network node and/or any other network equipment. Similarly, antenna 1562, interface 1590, and/or processing circuitry 1570 may be configured to perform any transmitting operations described herein as being performed by a network node. Any information, data and/or signals may be transmitted to a wireless device, another network node and/or any other network equipment.

Power circuitry 1587 may comprise, or be coupled to, power management circuitry and is configured to supply the components of network node 1560 with power for performing the functionality described herein. Power circuitry 1587 may receive power from power source 1586. Power source 1586 and/or power circuitry 1587 may be configured to provide power to the various components of network node 1560 in a form suitable for the respective components (e.g., at a voltage and current level needed for each respective component).

Power source 1586 may either be included in, or external to, power circuitry 1587 and/or network node 1560. For example, network node 1560 may be connectable to an external power source (e.g., an electricity outlet) via an input circuitry or interface such as an electrical cable, whereby the external power source supplies power to power circuitry 1587. As a further example, power source 1586 may comprise a source of power in the form of a battery or battery pack which is connected to, or integrated in, power circuitry 1587. The battery may provide backup power should the external power source fail. Other types of power sources, such as photovoltaic devices, may also be used.

Alternative embodiments of network node 1560 may include additional components beyond those shown in FIG. 15 that may be responsible for providing certain aspects of the network node's functionality, including any of the functionality described herein and/or any functionality necessary to support the subject matter described herein. For example, network node 1560 may include user interface equipment to allow input of information into network node 1560 and to allow output of information from network node 1560. This may allow a user to perform diagnostic, maintenance, repair, and other administrative functions for network node 1560.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc.. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1510 includes antenna 1511, interface 1514, processing circuitry 1520, device readable medium 1530, user interface equipment 1532, auxiliary equipment 1534, power source 1536 and power circuitry 1537. WD 1510 may include multiple sets of one or more of the illustrated components for different wireless technologies supported by WD 1510, such as, for example, GSM, WCDMA, LTE, NR, WiFi, WiMAX, or Bluetooth wireless technologies, just to mention a few. These wireless technologies may be integrated into the same or different chips or set of chips as other components within WD 1510.

Antenna 1511 may include one or more antennas or antenna arrays, configured to send and/or receive wireless signals, and is connected to interface 1514. In certain alternative embodiments, antenna 1511 may be separate from WD 1510 and be connectable to WD 1510 through an interface or port. Antenna 1511, interface 1514, and/or processing circuitry 1520 may be configured to perform any receiving or transmitting operations described herein as being performed by a WD. Any information, data and/or signals may be received from a network node and/or another WD. In some embodiments, radio front end circuitry and/or antenna 1511 may be considered an interface.

As illustrated, interface 1514 comprises radio front end circuitry 1512 and antenna 1511. Radio front end circuitry 1512 comprise one or more filters 1518 and amplifiers 1516. Radio front end circuitry 1514 is connected to antenna 1511 and processing circuitry 1520, and is configured to condition signals communicated between antenna 1511 and processing circuitry 1520. Radio front end circuitry 1512 may be coupled to or a part of antenna 1511. In some embodiments, WD 1510 may not include separate radio front end circuitry 1512; rather, processing circuitry 1520 may comprise radio front end circuitry and may be connected to antenna 1511. Similarly, in some embodiments, some or all of RF transceiver circuitry 1522 may be considered a part of interface 1514. Radio front end circuitry 1512 may receive digital data that is to be sent out to other network nodes or WDs via a wireless connection. Radio front end circuitry 1512 may convert the digital data into a radio signal having the appropriate channel and bandwidth parameters using a combination of filters 1518 and/or amplifiers 1516. The radio signal may then be transmitted via antenna 1511. Similarly, when receiving data, antenna 1511 may collect radio signals which are then converted into digital data by radio front end circuitry 1512. The digital data may be passed to processing circuitry 1520. In other embodiments, the interface may comprise different components and/or different combinations of components.

Processing circuitry 1520 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1510 components, such as device readable medium 1530, WD 1510 functionality. Such functionality may include providing any of the various wireless features or benefits discussed herein. For example, processing circuitry 1520 may execute instructions stored in device readable medium 1530 or in memory within processing circuitry 1520 to provide the functionality disclosed herein.

As illustrated, processing circuitry 1520 includes one or more of RF transceiver circuitry 1522, baseband processing circuitry 1524, and application processing circuitry 1526. In other embodiments, the processing circuitry may comprise different components and/or different combinations of components. In certain embodiments processing circuitry 1520 of WD 1510 may comprise a SOC. In some embodiments, RF transceiver circuitry 1522, baseband processing circuitry 1524, and application processing circuitry 1526 may be on separate chips or sets of chips. In alternative embodiments, part or all of baseband processing circuitry 1524 and application processing circuitry 1526 may be combined into one chip or set of chips, and RF transceiver circuitry 1522 may be on a separate chip or set of chips. In still alternative embodiments, part or all of RF transceiver circuitry 1522 and baseband processing circuitry 1524 may be on the same chip or set of chips, and application processing circuitry 1526 may be on a separate chip or set of chips. In yet other alternative embodiments, part or all of RF transceiver circuitry 1522, baseband processing circuitry 1524, and application processing circuitry 1526 may be combined in the same chip or set of chips. In some embodiments, RF transceiver circuitry 1522 may be a part of interface 1514. RF transceiver circuitry 1522 may condition RF signals for processing circuitry 1520.

In certain embodiments, some or all of the functionality described herein as being performed by a WD may be provided by processing circuitry 1520 executing instructions stored on device readable medium 1530, which in certain embodiments may be a computer-readable storage medium. In alternative embodiments, some or all of the functionality may be provided by processing circuitry 1520 without executing instructions stored on a separate or discrete device readable storage medium, such as in a hard-wired manner. In any of those particular embodiments, whether executing instructions stored on a device readable storage medium or not, processing circuitry 1520 can be configured to perform the described functionality. The benefits provided by such functionality are not limited to processing circuitry 1520 alone or to other components of WD 1510, but are enjoyed by WD 1510 as a whole, and/or by end users and the wireless network generally.

Processing circuitry 1520 may be configured to perform any determining, calculating, or similar operations (e.g., certain obtaining operations) described herein as being performed by a WD. These operations, as performed by processing circuitry 1520, may include processing information obtained by processing circuitry 1520 by, for example, converting the obtained information into other information, comparing the obtained information or converted information to information stored by WD 1510, and/or performing one or more operations based on the obtained information or converted information, and as a result of said processing making a determination.

Device readable medium 1530 may be operable to store a computer program, software, an application including one or more of logic, rules, code, tables, etc. and/or other instructions capable of being executed by processing circuitry 1520. Device readable medium 1530 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1520. In some embodiments, processing circuitry 1520 and device readable medium 1530 may be considered to be integrated.

User interface equipment 1532 may provide components that allow for a human user to interact with WD 1510. Such interaction may be of many forms, such as visual, audial, tactile, etc. User interface equipment 1532 may be operable to produce output to the user and to allow the user to provide input to WD 1510. The type of interaction may vary depending on the type of user interface equipment 1532 installed in WD 1510. For example, if WD 1510 is a smart phone, the interaction may be via a touch screen; if WD 1510 is a smart meter, the interaction may be through a screen that provides usage (e.g., the number of gallons used) or a speaker that provides an audible alert (e.g., if smoke is detected). User interface equipment 1532 may include input interfaces, devices and circuits, and output interfaces, devices and circuits. User interface equipment 1532 is configured to allow input of information into WD 1510, and is connected to processing circuitry 1520 to allow processing circuitry 1520 to process the input information. User interface equipment 1532 may include, for example, a microphone, a proximity or other sensor, keys/buttons, a touch display, one or more cameras, a USB port, or other input circuitry. User interface equipment 1532 is also configured to allow output of information from WD 1510, and to allow processing circuitry 1520 to output information from WD 1510. User interface equipment 1532 may include, for example, a speaker, a display, vibrating circuitry, a USB port, a headphone interface, or other output circuitry. Using one or more input and output interfaces, devices, and circuits, of user interface equipment 1532, WD 1510 may communicate with end users and/or the wireless network, and allow them to benefit from the functionality described herein.

Auxiliary equipment 1534 is operable to provide more specific functionality which may not be generally performed by WDs. This may comprise specialized sensors for doing measurements for various purposes, interfaces for additional types of communication such as wired communications etc. The inclusion and type of components of auxiliary equipment 1534 may vary depending on the embodiment and/or scenario.

Power source 1536 may, in some embodiments, be in the form of a battery or battery pack. Other types of power sources, such as an external power source (e.g., an electricity outlet), photovoltaic devices or power cells, may also be used. WD 1510 may further comprise power circuitry 1537 for delivering power from power source 1536 to the various parts of WD 1510 which need power from power source 1536 to carry out any functionality described or indicated herein. Power circuitry 1537 may in certain embodiments comprise power management circuitry. Power circuitry 1537 may additionally or alternatively be operable to receive power from an external power source; in which case WD 1510 may be connectable to the external power source (such as an electricity outlet) via input circuitry or an interface such as an electrical power cable.

Power circuitry 1537 may also in certain embodiments be operable to deliver power from an external power source to power source 1536. This may be, for example, for the charging of power source 1536. Power circuitry 1537 may perform any formatting, converting, or other modification to the power from power source 1536 to make the power suitable for the respective components of WD 1510 to which power is supplied.

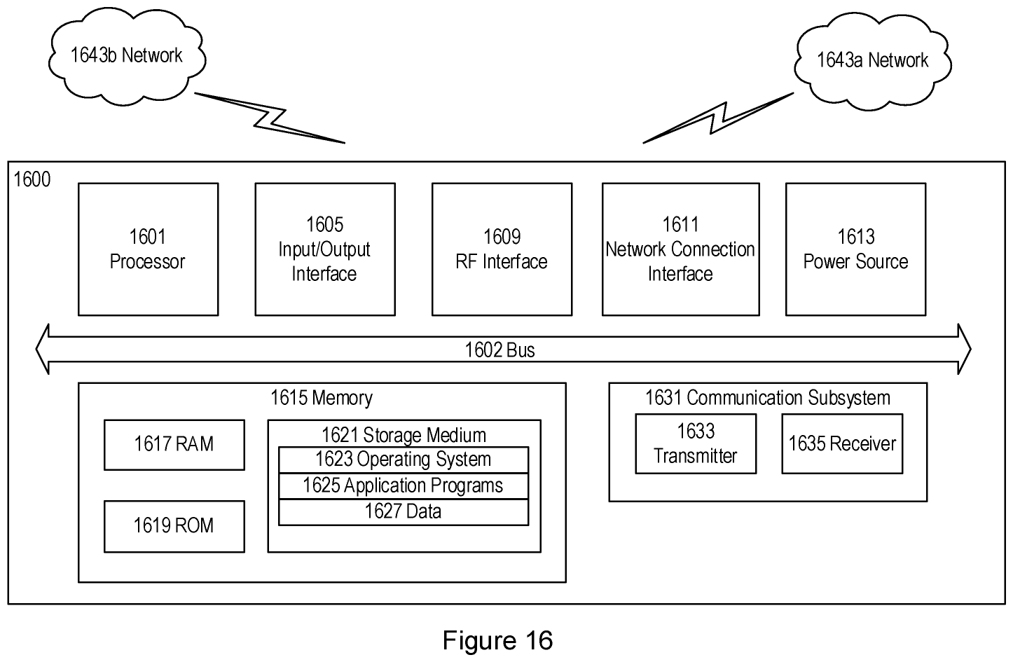

FIG. 16 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1600 may be any UE identified by the 3rd Generation Partnership Project (3GPP), including a NB-IoT UE, a machine type communication (MTC) UE, and/or an enhanced MTC (eMTC) UE. UE 1600, as illustrated in FIG. 16, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 16 is a UE, the components discussed herein are equally applicable to a WD, and vice-versa.

In FIG. 16, UE 1600 includes processing circuitry 1601 that is operatively coupled to input/output interface 1605, radio frequency (RF) interface 1609, network connection interface 1611, memory 1615 including random access memory (RAM) 1617, read-only memory (ROM) 1619, and storage medium 1621 or the like, communication subsystem 1631, power source 1633, and/or any other component, or any combination thereof. Storage medium 1621 includes operating system 1623, application program 1625, and data 1627. In other embodiments, storage medium 1621 may include other similar types of information. Certain UEs may utilize all of the components shown in FIG. 16, or only a subset of the components. The level of integration between the components may vary from one UE to another UE. Further, certain UEs may contain multiple instances of a component, such as multiple processors, memories, transceivers, transmitters, receivers, etc.

In FIG. 16, processing circuitry 1601 may be configured to process computer instructions and data. Processing circuitry 1601 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1601 may include two central processing units (CPUs). Data may be information in a form suitable for use by a computer.

In the depicted embodiment, input/output interface 1605 may be configured to provide a communication interface to an input device, output device, or input and output device. UE 1600 may be configured to use an output device via input/output interface 1605. An output device may use the same type of interface port as an input device. For example, a USB port may be used to provide input to and output from UE 1600. The output device may be a speaker, a sound card, a video card, a display, a monitor, a printer, an actuator, an emitter, a smartcard, another output device, or any combination thereof. UE 1600 may be configured to use an input device via input/output interface 1605 to allow a user to capture information into UE 1600. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor. In FIG. 16, RF interface 1609 may be configured to provide a communication interface to RF components such as a transmitter, a receiver, and an antenna. Network connection interface 1611 may be configured to provide a communication interface to network 1643a. Network 1643a may encompass wired and/or wireless networks such as a local-area network (LAN), a wide-area network (WAN), a computer network, a wireless network, a telecommunications network, another like network or any combination thereof. For example, network 1643a may comprise a Wi-Fi network. Network connection interface 1611 may be configured to include a receiver and a transmitter interface used to communicate with one or more other devices over a communication network according to one or more communication protocols, such as Ethernet, TCP/IP, SONET, ATM, or the like. Network connection interface 1611 may implement receiver and transmitter functionality appropriate to the communication network links (e.g., optical, electrical, and the like). The transmitter and receiver functions may share circuit components, software or firmware, or alternatively may be implemented separately.

RAM 1617 may be configured to interface via bus 1602 to processing circuitry 1601 to provide storage or caching of data or computer instructions during the execution of software programs such as the operating system, application programs, and device drivers. ROM 1619 may be configured to provide computer instructions or data to processing circuitry 1601. For example, ROM 1619 may be configured to store invariant low-level system code or data for basic system functions such as basic input and output (I/O), startup, or reception of keystrokes from a keyboard that are stored in a non-volatile memory. Storage medium 1621 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1621 may be configured to include operating system 1623, application program 1625 such as a web browser application, a widget or gadget engine or another application, and data file 1627. Storage medium 1621 may store, for use by UE 1600, any of a variety of various operating systems or combinations of operating systems.

Storage medium 1621 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DI MM), synchronous dynamic random access memory (SDRAM), external micro-DIMM SDRAM, smartcard memory such as a subscriber identity module or a removable user identity (SIM/RUIM) module, other memory, or any combination thereof. Storage medium 1621 may allow UE 1600 to access computer-executable instructions, application programs or the like, stored on transitory or non-transitory memory media, to off-load data, or to upload data. An article of manufacture, such as one utilizing a communication system may be tangibly embodied in storage medium 1621, which may comprise a device readable medium.

In FIG. 16, processing circuitry 1601 may be configured to communicate with network 1643b using communication subsystem 1631. Network 1643a and network 1643b may be the same network or networks or different network or networks. Communication subsystem 1631 may be configured to include one or more transceivers used to communicate with network 1643b. For example, communication subsystem 1631 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1633 and/or receiver 1635 to implement transmitter or receiver functionality, respectively, appropriate to the RAN links (e.g., frequency allocations and the like). Further, transmitter 1633 and receiver 1635 of each transceiver may share circuit components, software or firmware, or alternatively may be implemented separately.

In the illustrated embodiment, the communication functions of communication subsystem 1631 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1631 may include cellular communication, Wi-Fi communication, Bluetooth communication, and GPS communication. Network 1643b may encompass wired and/or wireless networks such as a local-area network (LAN), a wide-area network (WAN), a computer network, a wireless network, a telecommunications network, another like network or any combination thereof. For example, network 1643b may be a cellular network, a Wi-Fi network, and/or a near-field network. Power source 1613 may be configured to provide alternating current (AC) or direct current (DC) power to components of UE 1600.

10 The features, benefits and/or functions described herein may be implemented in one of the components of UE 1600 or partitioned across multiple components of UE 1600. Further, the features, benefits, and/or functions described herein may be implemented in any combination of hardware, software or firmware. In one example, communication subsystem 1631 may be configured to include any of the components described herein. Further, processing circuitry 1601 may be configured to communicate with any of such components over bus 1602. In another example, any of such components may be represented by program instructions stored in memory that when executed by processing circuitry 1601 perform the corresponding functions described herein. In another example, the functionality of any of such components may be partitioned between processing circuitry 1601 and communication subsystem 1631. In another example, the non-computationally intensive functions of any of such components may be implemented in software or firmware and the computationally intensive functions may be implemented in hardware.

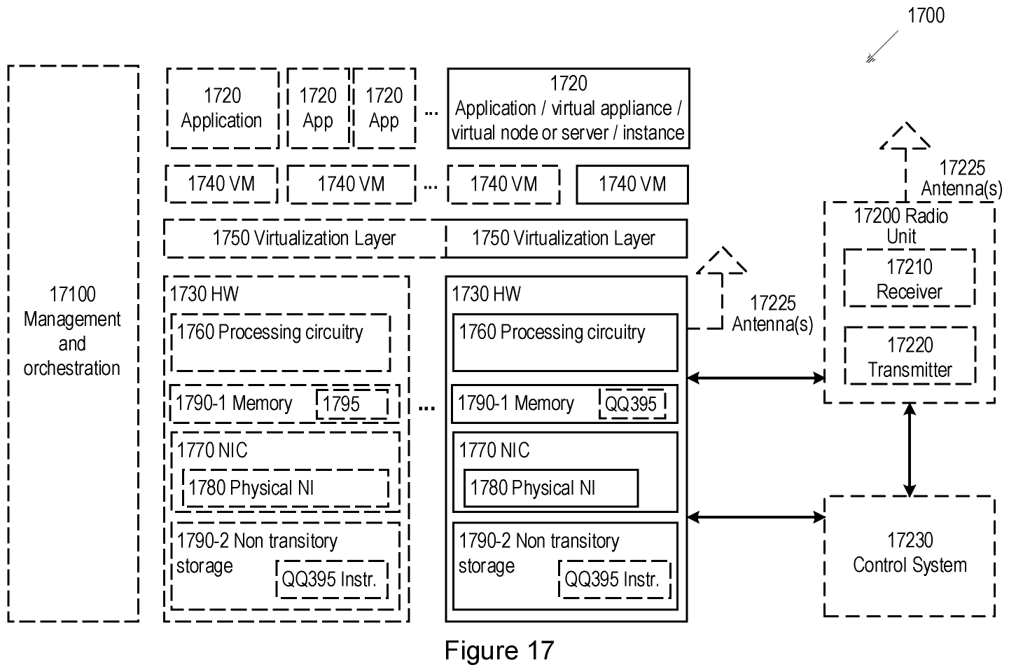

FIG. 17 is a schematic block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1700 hosted by one or more of hardware nodes 1730. Further, in embodiments in which the virtual node is not a radio access node or does not require radio connectivity (e.g., a core network node), then the network node may be entirely virtualized.

The functions may be implemented by one or more applications 1720 (which may alternatively be called software instances, virtual appliances, network functions, virtual nodes, virtual network functions, etc.) operative to implement some of the features, functions, and/or benefits of some of the embodiments disclosed herein. Applications 1720 are run in virtualization environment 1700 which provides hardware 1730 comprising processing circuitry 1760 and memory 1790. Memory 1790 contains instructions 1795 executable by processing circuitry 1760 whereby application 1720 is operative to provide one or more of the features, benefits, and/or functions disclosed herein.

Virtualization environment 1700, comprises general-purpose or special-purpose network hardware devices 1730 comprising a set of one or more processors or processing circuitry 1760, which may be commercial off-the-shelf (COTS) processors, dedicated Application Specific Integrated Circuits (ASICs), or any other type of processing circuitry including digital or analog hardware components or special purpose processors. Each hardware device may comprise memory 1790-1 which may be non-persistent memory for temporarily storing instructions 1795 or software executed by processing circuitry 1760. Each hardware device may comprise one or more network interface controllers (NICs) 1770, also known as network interface cards, which include physical network interface 1780. Each hardware device may also include non-transitory, persistent, machine-readable storage media 1790-2 having stored therein software 1795 and/or instructions executable by processing circuitry 1760. Software 1795 may include any type of software including software for instantiating one or more virtualization layers 1750 (also referred to as hypervisors), software to execute virtual machines 1740 as well as software allowing it to execute functions, features and/or benefits described in relation with some embodiments described herein.

Virtual machines 1740, comprise virtual processing, virtual memory, virtual networking or interface and virtual storage, and may be run by a corresponding virtualization layer 1750 or hypervisor. Different embodiments of the instance of virtual appliance 1720 may be implemented on one or more of virtual machines 1740, and the implementations may be made in different ways.

During operation, processing circuitry 1760 executes software 1795 to instantiate the hypervisor or virtualization layer 1750, which may sometimes be referred to as a virtual machine monitor (VMM). Virtualization layer 1750 may present a virtual operating platform that appears like networking hardware to virtual machine 1740.

As shown in FIG. 17, hardware 1730 may be a standalone network node with generic or specific components. Hardware 1730 may comprise antenna 17225 and may implement some functions via virtualization. Alternatively, hardware 1730 may be part of a larger cluster of hardware (e.g. such as in a data center or customer premise equipment (CPE)) where many hardware nodes work together and are managed via management and orchestration (MANO) 17100, which, among others, oversees lifecycle management of applications 1720.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1740 may be a software implementation of a physical machine that runs programs as if they were executing on a physical, non-virtualized machine. Each of virtual machines 1740, and that part of hardware 1730 that executes that virtual machine, be it hardware dedicated to that virtual machine and/or hardware shared by that virtual machine with others of the virtual machines 1740, forms a separate virtual network elements (VNE).

Still in the context of NFV, Virtual Network Function (VNF) is responsible for handling specific network functions that run in one or more virtual machines 1740 on top of hardware networking infrastructure 1730 and corresponds to application 1720 in FIG. 17.

In some embodiments, one or more radio units 17200 that each include one or more transmitters 17220 and one or more receivers 17210 may be coupled to one or more antennas 17225. Radio units 17200 may communicate directly with hardware nodes 1730 via one or more appropriate network interfaces and may be used in combination with the virtual components to provide a virtual node with radio capabilities, such as a radio access node or a base station.

In some embodiments, some signalling can be effected with the use of control system 17230 which may alternatively be used for communication between the hardware nodes 1730 and radio units 17200.

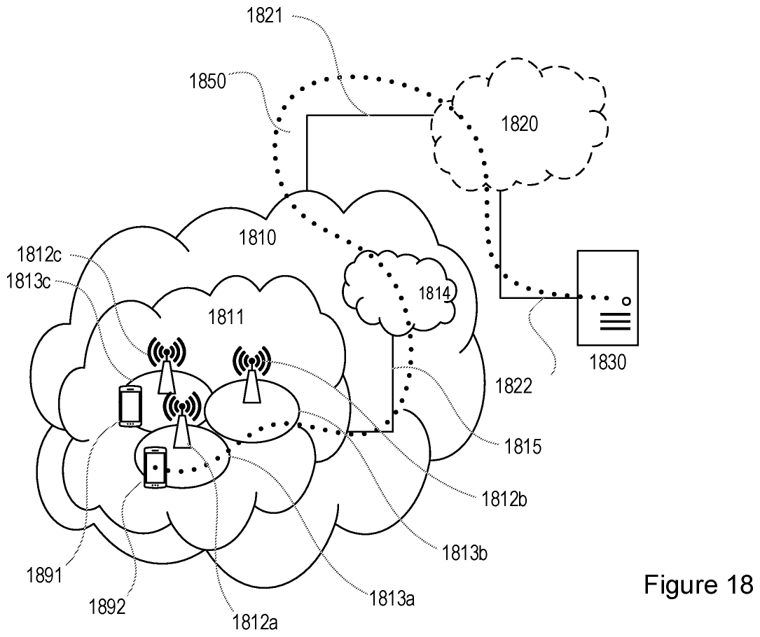

With reference to FIG. 18, in accordance with an embodiment, a communication system includes telecommunication network 1810, such as a 3GPP-type cellular network, which comprises access network 1811, such as a radio access network, and core network 1814. Access network 1811 comprises a plurality of base stations 1812a, 1812b, 1812c, such as NBs, eNBs, gNBs or other types of wireless access points, each defining a corresponding coverage area 1813a, 1813b, 1813c. Each base station 1812a, 1812b, 1812c is connectable to core network 1814 over a wired or wireless connection 1815. A first UE 1891 located in coverage area 1813c is configured to wirelessly connect to, or be paged by, the corresponding base station 1812c. A second UE 1892 in coverage area 1813a is wirelessly connectable to the corresponding base station 1812a. While a plurality of UEs 1891, 1892 are illustrated in this example, the disclosed embodiments are equally applicable to a situation where a sole UE is in the coverage area or where a sole UE is connecting to the corresponding base station 1812.

Telecommunication network 1810 is itself connected to host computer 1830, which may be embodied in the hardware and/or software of a standalone server, a cloud-implemented server, a distributed server or as processing resources in a server farm. Host computer 1830 may be under the ownership or control of a service provider, or may be operated by the service provider or on behalf of the service provider. Connections 1821 and 1822 between telecommunication network 1810 and host computer 1830 may extend directly from core network 1814 to host computer 1830 or may go via an optional intermediate network 1820. Intermediate network 1820 may be one of, or a combination of more than one of, a public, private or hosted network; intermediate network 1820, if any, may be a backbone network or the Internet; in particular, intermediate network 1820 may comprise two or more sub-networks (not shown).

The communication system of FIG. 18 as a whole enables connectivity between the connected UEs 1891, 1892 and host computer 1830. The connectivity may be described as an over-the-top (OTT) connection 1850. Host computer 1830 and the connected UEs 1891, 1892 are configured to communicate data and/or signaling via OTT connection 1850, using access network 1811, core network 1814, any intermediate network 1820 and possible further infrastructure (not shown) as intermediaries. OTT connection 1850 may be transparent in the sense that the participating communication devices through which OTT connection 1850 passes are unaware of routing of uplink and downlink communications. For example, base station 1812 may not or need not be informed about the past routing of an incoming downlink communication with data originating from host computer 1830 to be forwarded (e.g., handed over) to a connected UE 1891. Similarly, base station 1812 need not be aware of the future routing of an outgoing uplink communication originating from the UE 1891 towards the host computer 1830.

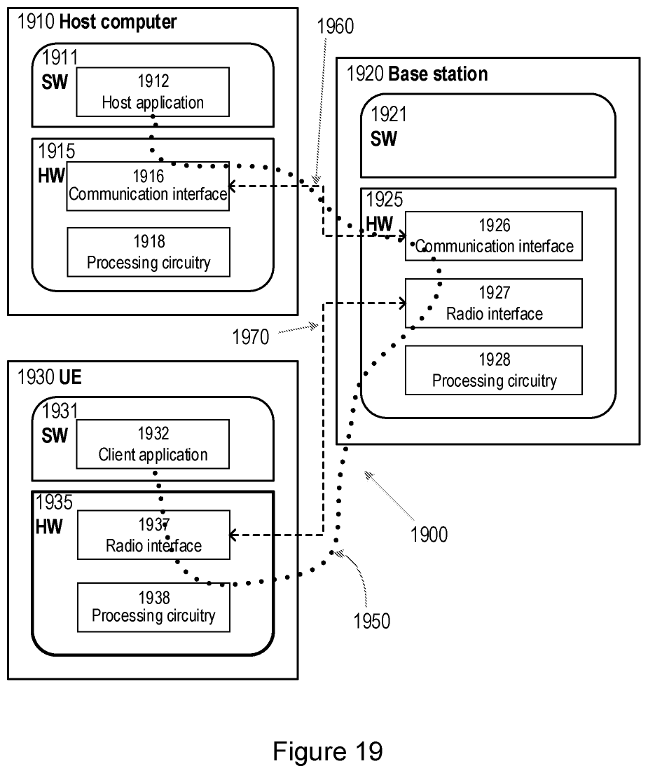

Example implementations, in accordance with an embodiment, of the UE, base station and host computer discussed in the preceding paragraphs will now be described with reference to FIG. 19. In communication system 1900, host computer 1910 comprises hardware 1915 including communication interface 1916 configured to set up and maintain a wired or wireless connection with an interface of a different communication device of communication system 1900. Host computer 1910 further comprises processing circuitry 1918, which may have storage and/or processing capabilities. In particular, processing circuitry 1918 may comprise one or more programmable processors, application-specific integrated circuits, field programmable gate arrays or combinations of these (not shown) adapted to execute instructions. Host computer 1910 further comprises software 1911, which is stored in or accessible by host computer 1910 and executable by processing circuitry 1918. Software 1911 includes host application 1912. Host application 1912 may be operable to provide a service to a remote user, such as UE 1930 connecting via OTT connection 1950 terminating at UE 1930 and host computer 1910. In providing the service to the remote user, host application 1912 may provide user data which is transmitted using OTT connection 1950.

Communication system 1900 further includes base station 1920 provided in a telecommunication system and comprising hardware 1925 enabling it to communicate with host computer 1910 and with UE 1930.

Hardware 1925 may include communication interface 1926 for setting up and maintaining a wired or wireless connection with an interface of a different communication device of communication system 1900, as well as radio interface 1927 for setting up and maintaining at least wireless connection 1970 with UE 1930 located in a coverage area (not shown in FIG. 19) served by base station 1920. Communication interface 1926 may be configured to facilitate connection 1960 to host computer 1910. Connection 1960 may be direct or it may pass through a core network (not shown in FIG. 19) of the telecommunication system and/or through one or more intermediate networks outside the telecommunication system. In the embodiment shown, hardware 1925 of base station 1920 further includes processing circuitry 1928, which may comprise one or more programmable processors, application-specific integrated circuits, field programmable gate arrays or combinations of these (not shown) adapted to execute instructions. Base station 1920 further has software 1921 stored internally or accessible via an external connection.

Communication system 1900 further includes UE 1930 already referred to. Its hardware 1935 may include radio interface 1937 configured to set up and maintain wireless connection 1970 with a base station serving a coverage area in which UE 1930 is currently located. Hardware 1935 of UE 1930 further includes processing circuitry 1938, which may comprise one or more programmable processors, application-specific integrated circuits, field programmable gate arrays or combinations of these (not shown) adapted to execute instructions. UE 1930 further comprises software 1931, which is stored in or accessible by UE 1930 and executable by processing circuitry 1938. Software 1931 includes client application 1932. Client application 1932 may be operable to provide a service to a human or non-human user via UE 1930, with the support of host computer 1910. In host computer 1910, an executing host application 1912 may communicate with the executing client application 1932 via OTT connection 1950 terminating at UE 1930 and host computer 1910. In providing the service to the user, client application 1932 may receive request data from host application 1912 and provide user data in response to the request data. OTT connection 1950 may transfer both the request data and the user data. Client application 1932 may interact with the user to generate the user data that it provides.

It is noted that host computer 1910, base station 1920 and UE 1930 illustrated in FIG. 19 may be similar or identical to host computer 1830, one of base stations 1812a, 1812b, 1812c and one of UEs 1891, 1892 of FIG. 18, respectively. This is to say, the inner workings of these entities may be as shown in FIG. 19 and independently, the surrounding network topology may be that of FIG. 18.

In FIG. 19, OTT connection 1950 has been drawn abstractly to illustrate the communication between host computer 1910 and UE 1930 via base station 1920, without explicit reference to any intermediary devices and the precise routing of messages via these devices. Network infrastructure may determine the routing, which it may be configured to hide from UE 1930 or from the service provider operating host computer 1910, or both. While OTT connection 1950 is active, the network infrastructure may further take decisions by which it dynamically changes the routing (e.g., on the basis of load balancing consideration or reconfiguration of the network).

Wireless connection 1970 between UE 1930 and base station 1920 is in accordance with the teachings of the embodiments described throughout this disclosure. One or more of the various embodiments improve the performance of OTT services provided to UE 1930 using OTT connection 1950, in which wireless connection 1970 forms the last segment.

A measurement procedure may be provided for the purpose of monitoring data rate, latency and other factors on which the one or more embodiments improve. There may further be an optional network functionality for reconfiguring OTT connection 1950 between host computer 1910 and UE 1930, in response to variations in the measurement results. The measurement procedure and/or the network functionality for reconfiguring OTT connection 1950 may be implemented in software 1911 and hardware 1915 of host computer 1910 or in software 1931 and hardware 1935 of UE 1930, or both. In embodiments, sensors (not shown) may be deployed in or in association with communication devices through which OTT connection 1950 passes; the sensors may participate in the measurement procedure by supplying values of the monitored quantities exemplified above, or supplying values of other physical quantities from which software 1911, 1931 may compute or estimate the monitored quantities. The reconfiguring of OTT connection 1950 may include message format, retransmission settings, preferred routing etc.; the reconfiguring need not affect base station 1920, and it may be unknown or imperceptible to base station 1920. Such procedures and functionalities may be known and practiced in the art. In certain embodiments, measurements may involve proprietary UE signaling facilitating host computer 1910's measurements of throughput, propagation times, latency and the like. The measurements may be implemented in that software 1911 and 1931 causes messages to be transmitted, in particular empty or ‘dummy’ messages, using OTT connection 1950 while it monitors propagation times, errors etc.

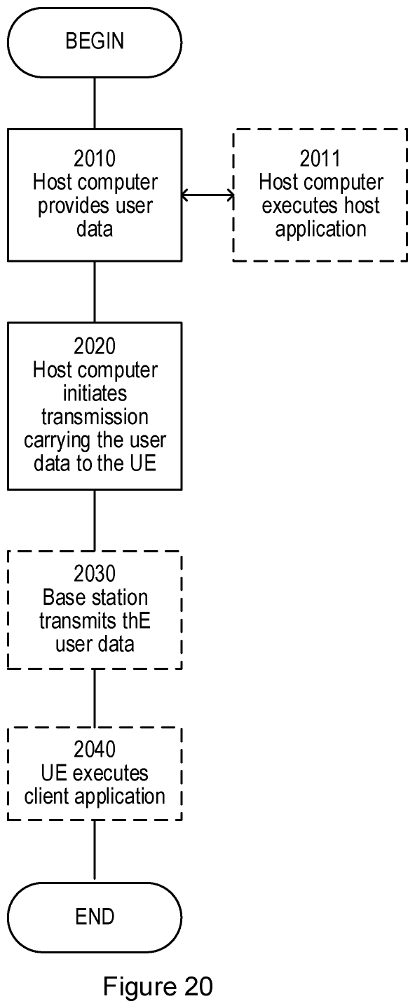

FIG. 20 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 20 will be included in this section. In step 2010, the host computer provides user data. In substep 2011 (which may be optional) of step 2010, the host computer provides the user data by executing a host application. In step 2020, the host computer initiates a transmission carrying the user data to the UE. In step 2030 (which may be optional), the base station transmits to the UE the user data which was carried in the transmission that the host computer initiated, in accordance with the teachings of the embodiments described throughout this disclosure. In step 2040 (which may also be optional), the UE executes a client application associated with the host application executed by the host computer.

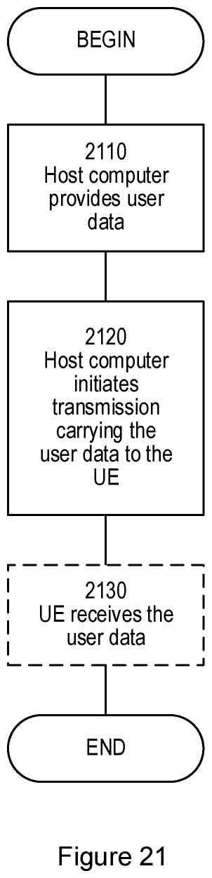

FIG. 21 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 21 will be included in this section. In step 2110 of the method, the host computer provides user data. In an optional substep (not shown) the host computer provides the user data by executing a host application. In step 2120, the host computer initiates a transmission carrying the user data to the UE. The transmission may pass via the base station, in accordance with the teachings of the embodiments described throughout this disclosure. In step 2130 (which may be optional), the UE receives the user data carried in the transmission.

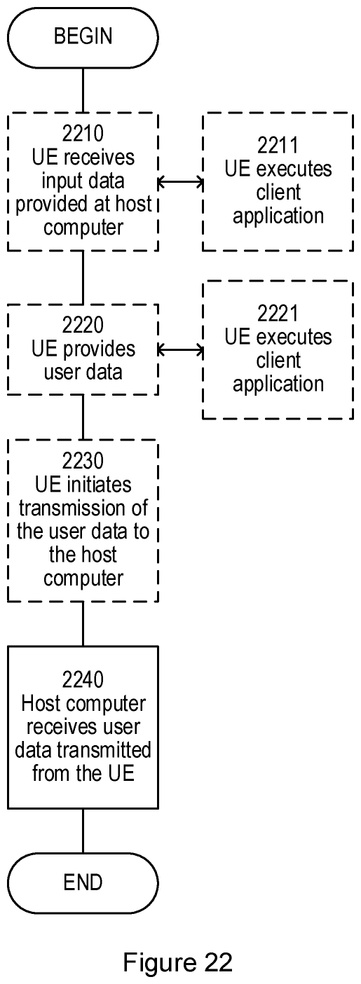

FIG. 22 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 22 will be included in this section. In step 2210 (which may be optional), the UE receives input data provided by the host computer. Additionally or alternatively, in step 2220, the UE provides user data. In substep 2221 (which may be optional) of step 2220, the UE provides the user data by executing a client application. In substep 2211 (which may be optional) of step 2210, the UE executes a client application which provides the user data in reaction to the received input data provided by the host computer. In providing the user data, the executed client application may further consider user input received from the user. Regardless of the specific manner in which the user data was provided, the UE initiates, in substep 2230 (which may be optional), transmission of the user data to the host computer. In step 2240 of the method, the host computer receives the user data transmitted from the UE, in accordance with the teachings of the embodiments described throughout this disclosure.

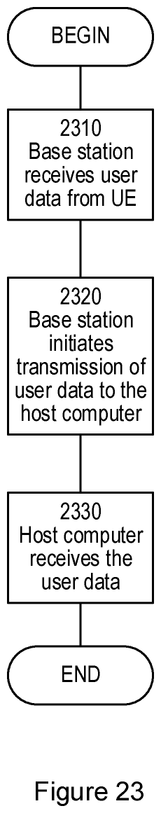

FIG. 23 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 23 will be included in this section. In step 2310 (which may be optional), in accordance with the teachings of the embodiments described throughout this disclosure, the base station receives user data from the UE. In step 2320 (which may be optional), the base station initiates transmission of the received user data to the host computer. In step 2330 (which may be optional), the host computer receives the user data carried in the transmission initiated by the base station.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims or numbered embodiments. The word “comprising” does not exclude the presence of elements or steps other than those listed in a claim or embodiment, “a” or “an” does not exclude a plurality, and a single processor or other unit may fulfil the functions of several units recited in the claims or numbered embodiments. Any reference signs in the claims or numbered embodiments shall not be construed so as to limit their scope.

1. A computer implemented method for managing a Radio Access Network, RAN, operation performed by a first node in a communication network that comprises a Radio Access Network, the method, performed by the first node, comprising:
receiving a representation of a state of a second node with respect to the RAN operation, wherein the state of the second node comprises a compressed representation of parameter values that describe at least one of a physical state, a radio environment or a physical environment experienced by the second node or experienced by at least one node that is connected to the communication network via the second node;
using the received state representation to generate a configuration action for the RAN operation; and
initiating configuration of the RAN operation in accordance with the generated configuration action.

2. The method of claim 1, further comprising:
obtaining a measure of success of the RAN operation configured in accordance with the generated configuration action; and
updating, based on the obtained success measure, how the received state representation is used to generate a configuration action for the RAN operation (150).

3. (canceled)

4. The method of claim 1, wherein using the received state representation to generate a configuration action for the RAN operation comprises:
using a Machine Learning, ML, process to generate the configuration action as a function of the state of the second node.

5. The method of claim 4, wherein using an ML process to generate the configuration action as a function of the state of the second node comprises at least one of:
inputting a representation of the state of the second node to an ML model trained for use in generating a configuration action;
executing a Reinforcement Learning, RL, process by:
using an ML model to predict a success measure for each of a plurality of possible configuration actions;
using a selection function to select the configuration action based on the predicted success measures and an exploration component; and
following execution of the RAN operation configured according to the configuration action, updating the ML model for predicting success measures;
executing a Reinforcement Learning, RL, process by:
using an ML model to predict the probability of executing each of a plurality of possible configuration actions;
using a selection function to select the configuration action based on the predicted probability for each action; and
following execution of the RAN operation configured according to the configuration action, updating the ML model generating the probability for each possible action based on an obtained measure of success of the RAN operation.

6. (canceled)

7. (canceled)

8. The method of claim 5, wherein executing an RL process for generating a configuration action comprises:
inputting a representation of the state of the second node to the ML model for predicting a success measure for possible configuration actions;
selecting a configuration action based on the predicted success measures for possible actions;
obtaining a measure of success of the RAN operation configured in accordance with the generated configuration action; and
updating the ML model on the basis of the obtained measure of success.

9. The method of claim 4, further comprising at least one of:
obtaining an ML model for use in generating a configuration action;
training an ML model for use in generating a configuration action.

10. (canceled)

11. (canceled)

12. The method of claim 1, wherein the received representation of a state of the second node comprises at least one of:
a state identifier for the state of the second node;
the compressed representation of parameter values that comprises the state; or
an indication of difference from a previous state of the second node;
and wherein a state identifier for a state of a second node comprises an identifier that is unique to a method used to generate the compressed representation of parameter values that comprises the state.

13. (canceled)

14. The method of claim 12, wherein obtaining an ML model for use in generating a configuration action comprises obtaining an ML model that corresponds to the received state identifier.

15. The method of claim 14, further comprising:
if an ML model that corresponds to the received state identifier cannot be obtained, and if fewer than a threshold number of second nodes have reported the received state identifier:
instructing the second node to use a legacy reporting procedure for the RAN operation;
if an ML model that corresponds to the received state identifier cannot be obtained, and if at least a threshold number of second nodes have reported the received state identifier:
training a new ML model for use in generating a configuration action from the received state identifier.

16-23. (canceled)

24. The method of claim 1, further comprising:
obtaining a measure of usefulness of the received representation of a state of the second node for configuration of the RAN operation; and
updating at least one of:
a process for using the received state representation to generate a configuration action for the RAN operation; or
a configuration for receipt of the state representation
on the basis of the obtained measure of usefulness.

25-31. (canceled)

32. A computer implemented method for facilitating a Radio Access Network, RAN, operation performed by a first node in a communication network that comprises a Radio Access Network, the method, performed by a second node, comprising:
generating a state of the second node with respect to the RAN operation, wherein the state of the second node comprises a compressed representation of parameter values that describe at least one of a physical state, a radio environment or a physical environment experienced by the second node or experienced by at least one node that is connected to the communication network via the second node; and
transmitting a representation of the generated state to at least one of the first node or a node of the communication network that is operable to communicate with the first node.

33. (canceled)

34. The method of claim 32, wherein generating a state of the second node with respect to the RAN operation comprises:
assembling parameter values for inclusion in the state; and
generating a compressed representation of the parameter values using a Machine Learning, ML, process.

35. The method of claim 34, wherein generating a compressed representation of the parameter values using an ML process comprises:
reducing a dimensionality of the assembled parameter values using a trained ML model.

36. The method of claim 35, wherein the trained ML model comprises at least one of:
an encoder part of an Autoencoder;
a model trained to execute a Principal Component Analysis process.

37. (canceled)

38. The method of claim 32, further comprising:
preparing a representation of the generated state for transmission.

39. The method of claim 38, wherein preparing a representation of the generated state for transmission comprises at least one of:
mapping the generated state to a state identifier for transmission;
assembling the compressed representation for transmission;
computing a difference between the generated state and a previous state of the second node.

40. The method of claim 39, wherein a state identifier for a state of a second node comprises an identifier that is unique to a method used to generate the compressed representation of parameter values that comprises the state.

41-49. (canceled)

50. The method of claim 32, further comprising:
obtaining a measure of usefulness of the transmitted representation of a state of the second node for configuration of the RAN operation; and
updating at least one of:
a process for generating the state of the second node; or
a parameter included with the transmitted representation of the generated state on the basis of the obtained measure of usefulness.

51-53. (canceled)

54. A non-transitory computer readable medium comprising having computer readable code embodied therein, the computer readable code being configured such that, on execution by a suitable computer or processor, the computer or processor is caused to, for managing a Radio Access Network, RAN, operation performed by a first node in a communication network that comprises a RAN:
receive a representation of a state of a second node with respect to the RAN operation, wherein the state of the second node comprises a compressed representation of parameter values that describe at least one of a physical state, a radio environment or a physical environment experienced by the second node or experienced by at least one node that is connected to the communication network via the second node;
use the received state representation to generate a configuration action for the RAN operation; and
initiate configuration of the RAN operation in accordance with the generated configuration action.

55. A first node in a communication network comprising a Radio Access Network, RAN, the first node for managing a RAN operation performed by the first node and comprising processing circuitry and memory, wherein the memory may contain instructions executable by the processing circuitry, and wherein the processing circuitry is configured to:
receive a representation of a state of a second node with respect to the RAN operation, wherein the state of the second node comprises a compressed representation of parameter values that describe at least one of a physical state, a radio environment or a physical environment experienced by the second node or by at least one node that is connected to the communication network via the second node;
use the received state representation to generate a configuration action for the RAN operation; and
initiate configuration of the RAN operation in accordance with the generated configuration action.

56. (canceled)

57. A second node in a communication network comprising a Radio Access Network, RAN, the second node for facilitating a RAN operation performed by a first node in the communication network and comprising processing circuitry and memory, wherein the memory may contain instructions executable by the processing circuitry, and wherein the processing circuitry is configured to:
generate a state of the second node with respect to the RAN operation, wherein the state of the second node comprises a compressed representation of parameter values that describe at least one of a physical state, a radio environment or a physical environment experienced by the second node or by at least one node that is connected to the communication network via the second node; and
transmit a representation of the generated state to at least one of the first node or a node of the communication network that is operable to communicate with the first node.

58. (canceled)
